(19) United States
(12) Patent Application Publication
(10) Pub. No.: US 2010/0125122 A1
(43) Pub. Date: May 20, 2010

(54) PROCESS FOR THE PRODUCTION OF A (CO)POLYMER COMPOSITION BY MEDIATED FREE RADICAL CHAIN GROWTH POLYMERIZATION

(76) Inventors: Gilbert C.E. Bouquet, Gent (BE); Gregory Chambard, Terneuzen (NL); Robert P. Dion, Midland, MI (US); Pascak E.R.E.J. Lakeman, Terneuzen (NL); Dominique Maes, Terneuzen (NL)

Correspondence Address: The Dow Chemical Company, Intellectual Property Section, P.O. Box 1967, Midland, MI, 48641-1967, US

(21) Appl. No.: 12/594,955

(22) PCT Filed: Mar. 13, 2008
(86) PCT No.: PCT/US08/56820

§ 371 Date: Oct. 7, 2009

Related U.S. Application Data
(60) Provisional application No. 60/926,144, filed on Apr. 25, 2007.

(51) Int. Cl. C08L 9/06

(52) U.S. Cl. 525/232

(57) ABSTRACT

The present invention is a multistage process for the preparation of a co)polymer composition. Said process comprises the steps of: i) polymerizing in a first stage a reaction mixture comprising one or more monomer with optionally a rubber, a comonomer, a polymerization initiator, a chain transfer agent, a decomposition catalyst and/or a solvent, in the presence of one or more stable free radical precursor which provides a stable free radical during the polymerization process and/or one or more stable free radical such that the polymerization proceeds via a mediated free radical polymerization mechanism until a partial conversion of monomer(s) to (co)polymer is obtained and ii) polymerizing in a second stage the partially converted reaction mixture under reaction conditions that proceed via a free radical polymerization mechanism to obtain a further degree of conversion of monomer(s) to (co)polymer.

### CROSS REFERENCE STATEMENT

This application claims the benefit of U.S. Provisional Application No. 60/926,144, filed Apr. 25, 2007.

### FIELD OF THE INVENTION

This invention relates to a process to produce a (co)polymer composition, with or without rubber modification, comprising a mediated radical polymerization stage and a free radical polymerization stage and compositions produced therefrom.

### BACKGROUND OF THE INVENTION

Resins obtained by radical growth (co)polymerization, in particular rubber-modified styrenic resins, are versatile because their mechanical, rheological, thermal and aesthetic properties (for example, toughness, melt flow rate, heat resistance, gloss, etc.) may be tailored for specific applications. These properties are related to polymer parameters such as (co)polymer molecular weight and molecular weight distribution, (co)polymer composition, and in the case of rubber-modified styrenic resins, rubber particle size, amount of grafting and/or cross-linking of the rubber, type of rubber, etc. However, in conventional polymerization process(es), these polymer parameters are often interdependent or tied together. In other words, they can not be varied independently. For example, rubber particle size is often coupled to matrix molecular weight. Optimizing one property, such as toughness, by fine tuning rubber particle size and matrix molecular weight will result in effecting another property, such as gloss or melt flow rate, in an undesirable way. Another example is the rate of polymerization. Changing the rate of polymerization will change the requirements for heat exchange, particle sizing and cross linking. If these parameters are not adjusted the final end product will not have the desired properties

There have been attempts to uncouple polymer parameters by performing the polymerization of rubber-modified vinyl aromatic polymers using mediated free radical polymerization conditions. EP 726280A1 discloses a rubber-modified polystyrene with improved impact resistance and flowability, which generally evolve in opposite directions. However, such improvements are at the cost of producing a bimodal rubber particle size distribution and reactions rates which are commercially prohibitive.

Attempts to improve unacceptable reaction rates resulting from mediated free radical polymerization by utilizing one or more polymerization initiator are disclosed in EP 927727A1, EP 1091988A1, and WO 2000035963A1 wherein producing a polymer with a narrow polydispersity is cited as the primary benefit to a mediated free radical polymerization process. However, these approaches impose limitations such as low and narrow processing temperature ranges, bimodal rubber particle size distribution, and rubber particles being partly salami and/or labyrinth morphology and at the same time a partly onion and/or capsule morphology. Moreover, while rates are improved, they still are not commercially viable largely due to the low and narrow temperature ranges required by the mediated free radical polymerization process. Further, EP 807640A1 discloses that even with the use of a polymerization initiator the benefits of mediated free radical polymerization, for example a narrow polydispersity, are forfeited if the process temperatures are raised.

It would be desirable to have an improved process capable of commercially viable rates wherein previously coupled or interdependent polymer parameters could be decoupled to provide styrenic resins, in particular rubber-modified styrenic resins, with previously unattainable improved combinations of properties, for example good toughness and good melt flow.

### SUMMARY OF THE INVENTION

The present invention is such a process. It is a multistage process for the preparation of a (co)polymer composition wherein the process comprises the steps of: i) polymerizing in a first stage a reaction mixture comprising one or more monomer, preferably a vinylidene monomer, diene monomer, olefinic monomer, allylic monomer, vinyl monomer, or mixtures thereof, most preferably a vinyl aromatic monomer; optionally, one or more rubber, preferably a rubber wherein its polymerization process is a mass, bulk, mass-suspension, or mass-solution process; optionally, one or more comonomer; optionally, one or more polymerization initiator, preferably dibenzoyl peroxide; 1,1-di(t-butyl peroxy)cyclohexane; t-butyl peroxy 2-ethyl hexanoate; or mixtures thereof; optionally, one or more chain transfer agent, preferably methyl styrene dimer, n-dodecylmercaptan, terpinoline, thioglycolate, fatty esters of linoleic acid, fatty esters of linolic acid, linseed oil, or mixtures thereof; optionally one or more decomposition catalyst; and optionally, a solvent, preferably ethylbenzene, in the presence of one or more stable free radical precursor which provides a stable free radical during the polymerization process and/or one or more stable free radical such that the polymerization proceeds via a mediated free radical polymerization mechanism until a partial conversion of (co)monomer to (co)polymer is obtained and ii) polymerizing in a second stage the partially converted reaction mixture under reaction conditions that proceed via a free radical polymerization mechanism to obtain a further degree of conversion of (co)monomer to (co)polymer.

Preferably in the multistage process described hereinabove the vinyl aromatic monomer is styrene, the comonomer is acrylonitrile, and the rubber is a 1,3-butadiene based rubber.

Preferably in the multistage process described hereinabove the stable free radical comprises an ═N—O. group and more preferably the stable free radical is 2,2,6,6-tetramethyl-1-piperindinyloxy, 4-oxo-2,2,6,6-tetramethyl-1-piperindinyloxy, 4-hydroxy-2,2,6,6-tetramethyl-1-piperindinyloxy, or mixtures thereof.

In a further embodiment, the multistage process described hereinabove further comprising the step of iii) preparing the one or more stable free radical precursor in a third stage under reaction conditions that proceed via an anionic polymerization mechanism.

In a further embodiment, the multistage process described hereinabove further comprising the step of iv) subjecting the resultant mixture of desired degree of conversion to conditions sufficient to remove any unreacted (co)monomer and optional solvent and, if present, to cross-link the rubber.

In another embodiment, the present invention is a polymerization process for the preparation of a (co)polymer composition, preferably a (co)polymer composition comprising a vinyl aromatic (co)polymer, wherein the process comprises the steps of: i) polymerizing in a 1^{st} polymerization stage a reaction mixture comprising one or more monomer, preferably a vinylidene monomer, diene monomer, olefinic monomer, allylic monomer, vinyl monomer, or mixtures thereof, most preferably a vinyl aromatic monomer; optionally, one or more rubber, preferably a rubber wherein its polymerization process is a mass, bulk, mass-suspension, or mass-solution process; optionally, one or more comonomer; optionally, one or more polymerization initiator, preferably dibenzoyl peroxide; 1,1-di(t-butyl peroxy)cyclohexane; t-butyl peroxy 2-ethyl hexanoate; or mixtures thereof; optionally, one or more chain transfer agent, preferably methyl styrene dimer, n-dodecylmercaptan, terpinoline, thioglycolate, fatty esters of linoleic acid, fatty esters of linolic acid, linseed oil, or mixtures thereof; optionally one or more decomposition catalyst; and optionally, a solvent, preferably ethylbenzene, in the presence of one or more stable free radical precursor which provides a stable free radical during the polymerization process and/or one or more stable free radical such that the polymerization proceeds via a mediated free radical polymerization mechanism until a partial conversion of (co)monomer to (co)polymer is obtained and ii) polymerizing in a 2^{nd} polymerization stage the partially converted reaction mixture proceeds to a further degree of conversion of (co)monomer to (co)polymer wherein the 1^{st} polymerization stage has a mediation constant, z′, greater than 150,000 and the 2^{nd} polymerization stage has a z′ of less than 150,000.

Preferably in the multistage process described hereinabove the vinyl aromatic monomer is styrene, the comonomer is acrylonitrile, and the rubber is a 1,3-butadiene based rubber.

Preferably in the polymerization process described hereinabove the stable free radical comprises an ═N—O. group and more preferably the stable free radical is 2,2,6,6-tetramethyl-1-piperindinyloxy, 4-oxo-2,2,6,6-tetramethyl-1-piperindinyloxy, 4-hydroxy-2,2,6,6-tetramethyl-1-piperindinyloxy, or mixtures thereof.

In a further embodiment, the polymerization process described hereinabove further comprising the step of iii) preparing the one or more stable free radical precursor in a third stage under reaction conditions that proceed via an anionic polymerization mechanism.

In a further embodiment, the polymerization process described hereinabove further comprising the step of iv) subjecting the resultant mixture of desired degree of conversion to conditions sufficient to remove any unreacted (co)monomer and optional solvent and, if present, to cross-link the rubber.

### BRIEF DESCRIPTION OF THE DRAWINGS

FIG. 1 shows the relationship between the mediation constant, z′, for a single stable free radical/monomer system as a function of temperature at a constant pressure of 4 bar further defined in Example 1.

FIG. 2 shows the polymerization activity as a function of temperature for two stable free radical mediated systems as measured by heat flow further defined in Example 1.

FIG. 3 shows the relationship between z′ for five different stable free radical/monomer(s) systems as a function of temperature further defined in Example 1.

FIG. 4 shows the polymerization activity as a function of temperature for Examples 13 to 16 and Comparative Example K as measured by heat flow.

FIG. 5 shows the polymerization activity as a function of temperature for Examples 17 to 20 and Comparative Example L as measured by heat flow.

FIG. 6 shows the polymerization activity as a function of temperature for Examples 21 to 24 and Comparative Example M as measured by heat flow.

FIG. 7 shows the relationship for z′ as a function of temperature for Examples 13 to 24.

FIG. 8 shows the relationship for z′ as a function of temperature for Examples 25 to 33.

FIG. 9 shows a transmission electron micrograph (TEM) of Comparative Example N.

FIG. 10 shows a TEM of Example 34.

FIG. 11 graphically represents z′ values versus reactor location for Examples 45 to 50.

FIG. 12 shows a TEM of Example 45

FIG. 13 shows a TEM of Example 46

FIG. 14 shows a TEM of Example 47

FIG. 15 shows a TEM of Example 48

FIG. 16 shows a TEM of Example 50

### DETAILED DESCRIPTION OF THE INVENTION

Despite its many benefits and widespread use, a significant drawback of conventional free radical polymerization (FRP) is the lack of control over the polymer structure due to the fast termination reactions. In FRP it is possible to control one among the different properties of the process or of the product parameters, such as polymerization rate, degree of polymerization, molecular weight, molecular weight distribution, end functionalities, and (co)polymer composition. However, it is not possible to control simultaneously all these properties and/or synthesis of more complex structures and block copolymers is impractical.

On the other hand, mediated free radical polymerization using a stable free radical has found limited commercial use due to their slow rates in spite of their many benefits. For example, in a stable free radical polymerization (SFRP) process it is possible to adjust the final degree of polymerization while keeping a narrow polymer molecular weight distribution. Further, by suitable selection of stable free radical(s), initiator(s), (co)monomer(s), rubber(s), etc. one can simultaneously control several process properties or product parameters such as: (co)polymer molecular weight; (co)polymer molecular weight distribution or polydispersity; the degree of branching and/or hyperbranching and/or dendritic branching; etc.; in the case of copolymers: composition and architecture of block copolymers, for example AB, ABA, ABAB copolymers, and the like, block/tapered copolymers.

The multi stage polymerization process of the present invention combines the simultaneous control of process and polymer properties of a SFRP process with the enhanced polymerization rate of a conventional FRP process. Additionally, the process of the present invention affords improvements in the distribution of heat of polymerization within the process; and in the case of rubber-modified polymers: torque reduction in the process; improvements in rubber grafting, including graft length, graft yield, and timing of grafting during the process; rubber particle sizing, rubber particle morphology, including occlusions, rubber membrane thickness; rubber cross-linking; replacement of expensive and/or exotic rubbers with less expensive and commonly available rubbers; transparent rubber-modified polymers; and weatherable rubber-modified polymers.

Conventional FRP can be described via a simplified set of fundamental reactions (neglecting thermal initiation, chain transfer, and side reactions):

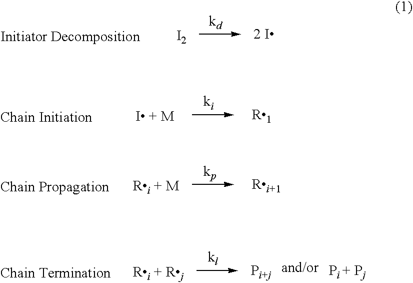

where I₂ is an initiator, M is a monomer, R.ᵢ is a radical of chain length i, and Pᵢ is a polymer of chain length i. Each reaction step described hereinabove is associated with a kinetic rate expression that contains a specific rate constant, k_{d} corresponds to the rate constant of initiator decomposition, kᵢ corresponds to the rate constant of initiation, kₚ corresponds to the rate constant of propagation, and kₜ corresponds to the rate constant of termination.

The rate of polymerization is defined as the rate of conversion of monomer to polymer and is essentially the same as the rate of propagation (assuming monomer consumed by initiation is negligible as per the traditional ‘long-chain assumption’):

Rₚ=kₚ[R.ᵢ][M] (2)

where Rₚ is the rate of polymerization. A good discussion of free radical polymerization can be found in J. Scheirs and D. Priddy, Modern Styrenic Polymers, John Wiley & Sons, New Jersey, 2003; K. Matyjaszewski and T. P. Davis, Handbook of Radical Polymerization, John Wiley & Sons, New Jersey, 2002; and K. Matyjaszewski, Controlled/Living Radical Polymerization, ACS Symposium Series 768, American Chemical Society, Washington, D.C., 2000.

Addition of certain kinds of compounds to a free radical polymerization process can alter the polymer product and process properties. For example, polymer molecular weight (unless otherwise noted is weight average molecular weight), polymer molecular weight distribution (this is defined as the weight average molecular weight (Mw) divided by the number average molecular weight (Mn) or Mw/Mn), and the rate of polymerization; in the case of copolymers, the architecture of the copolymer; and in the case of rubber-modified polymers, properties related to grafting and rubber morphology.

A family of compounds generally referred to as stable free radicals (SFR), can affect a free radical process and its resulting polymer product in different ways depending on the polymerization reaction conditions (for example, temperature, polarity, monomer(s), stable free radical structure, etc.). A stable free radical can act as an inhibitor, a mediator, or as a kinetic “neutral” species. A good example of such a stable free radical is a nitroxide compound, for example 2, 2,6,6-tetramethylpiperidine-1-oxyl (TEMPO).

Under a first set of process conditions, a stable free radical acts as a polymerization inhibitor (in other words, it stops/prevents the polymerization process) in that it reacts quickly and irreversibly with the free radicals that participate in the propagation step:

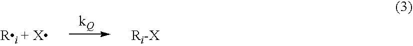

where k_{Q} is the rate constant of inhibition and X. is acting as an inhibitor species (see K. Matyjaszewski's Handbook of Radical Polymerization pages 235 to 237). The use of nitroxides as stable free radical for inhibition or trap for reactive free radicals is described in U.S. Pat. No. 3,163,677. The following kinetics are extracted from the hereinabove referenced Handbook of Radical Polymerization:

$$\frac{d [ {R}_{i} \cdot ]}{d t} = {R}_{ini} - 2 {{k}_{t} [ {R}_{i} \cdot ]}^{2} - {k}_{Q} [ {R}_{i} \cdot ] [ X \cdot ] = 0 \qquad ( 4 )$$

wherein Rᵢₙᵢ is the rate of radical generation and kₜ is the rate constant for termination. Eq. (4) in combination with Eq. (2), assuming the rate of loss of monomer, −d[M]/dt, equals the rate of polymerization (Rₚ), can be expressed as:

$${R}_{ini} - \frac{2 {K}_{t} {R}_{p}^{2}}{{{k}_{p}^{2} [ M ]}^{2}} - \frac{{k}_{Q} {R}_{p} [ X \cdot ]}{{k}_{p} [ M ]} = 0 \qquad ( 5 )$$

The ratio of the rate coefficients for retardation (k_{Q}) and propagation (kₚ) is referred to as the inhibition constant z (z=k_{Q}/kₚ). If z is large the middle term becomes negligible and Eq. 5 may be expressed as:

$${R}_{p} = \frac{{k}_{p} [ M ] {R}_{ini}}{{k}_{Q} [ X \cdot ]} \qquad ( 6 )$$

Eq. (6) shows that the polymerization rate is inversely proportional to z:

$${R}_{p} = \frac{[ M ] {R}_{ini}}{[ X \cdot ]} \times \frac{1}{z} . \qquad ( 7 )$$

If z is large, the monomer conversion remains nearly zero until the inhibitor species (X.) is consumed. When all inhibitor is consumed the polymerization will start as if no inhibitor was present. At this point, the polymerization will be characterized by free radical kinetics.

Under a second set of process conditions, a stable free radical can act as a mediator when it reacts quickly and reversibly with the free radicals that participate in the propagation step. A stable free radical should not be confused with free radicals with fleeting lifetimes (a few milliseconds), such as the free radicals (R.) present in FRP process(es) resulting from the usual polymerization initiator radicals (I.), for example, from peroxides, hydroperoxides and initiators of azo type. In contrast, stable free radicals generally tend to mediate or as mentioned above, they can inhibit the polymerization. While not wishing to be bound by any particular theory, it is thought that during this mean lifetime, the stable free radical can alternate between radical state (persistent radical, X.) and a dormant state (R₁-X):

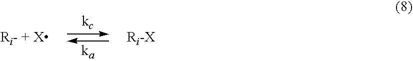

where kₐ corresponds to the rate constant of activation, k_{c} corresponds to the rate constant of combination, and Rᵢ a polymer chain of length i. Under mediation conditions, the rate constant of inhibition becomes the rate constant of combination, k_{Q}≡k_{c}. The equilibrium constant (K_{SFR}) for this reaction is defined as the rate constant of activation (kₐ) divided by the rate constant of combination (k_{c}):

$${K}_{SFR} = \frac{{k}_{a}}{{k}_{c}} \qquad ( 9 )$$

The use of nitroxides as stable free radical for mediation in free radical polymerization is described in U.S. Pat. No. 4,581,429.

Within the meaning of the present invention the mean lifetime of the reversible dormant/active stable free radical polymer chain is at least five minutes under the conditions of use of the polymerization process of the present invention. SFRP can be described via a simplified set of fundamental reactions (neglecting thermal initiation, chain transfer, and side reactions):

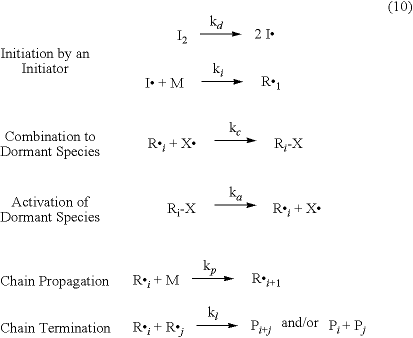

The radical concentration is described by:

$$[ R {\cdot }_{i} ] = \frac{[ {R}_{i} - X ]}{[ X \cdot ]} \frac{{k}_{a}}{{k}_{c}} \qquad ( 11 )$$

Substituting the radical concentration from Eq. (11) into the rate of polymerization equation Eq. (2) yields the rate equation for a mediated SFRP process:

$${R}_{p} = {k}_{p} ( \frac{[ {R}_{i} - X ]}{[ X \cdot ]} \frac{{k}_{a}}{{k}_{c}} ) [ M ] \qquad ( 12 )$$

To quantify the ability of a system to perform as a mediated polymerization process we have, in analogy with the inhibition constant (z), defined the mediation constant “z′”. The mediation constant is the ratio of the inhibition constant (z) and the rate constant of activation (kₐ):

$${z}^{′} = \frac{z}{{k}_{a}} = \frac{{k}_{Q}}{{k}_{a} {k}_{p}} ≡ \frac{{k}_{c}}{{k}_{a} {k}_{p}} = \frac{1}{{K}_{SFR} {k}_{p}} . \qquad ( 13 )$$

Thus, the polymerization rate for a stable free radical mediated polymerization process is inversely proportional to z′:

$${R}_{p} = {k}_{p} ( \frac{[ {R}_{i} - X ]}{[ X \cdot ]} {K}_{SFR} ) [ M ] \approx \frac{1}{{z}^{′}} \qquad ( 14 )$$

Under a third set of process conditions, where z′ is small, a stable free radial acts as a kinetic neutral species. Under these conditions, there is no longer inhibition or mediation and the polymerization will be characterized by free radical kinetics, Eq. (2).

A SFRP process is defined as a process wherein a polymer retains the ability to propagate for a long time and grow to a desired molecular weight while the degree of termination is negligible. Each chain will have a living end group and when initiation is fast the polymer will have a narrow molecular weight distribution. The SFRP process consists of the reversible combination of the growing chain, R.ᵢ, and the stable free radical or so-called “persistent radical”, X., to form dormant polymer chains, Rᵢ-X. It is preferable for the stable free radical to exhibit good stability throughout the duration of its use in the context of the present invention. Generally, a stable free radical can be isolated in the radical state at room temperature.

As a polymerization mediator, a stable free radical is generally far too stable to be able to initiate polymerization, but it is reactive enough to undergo reaction with other free radicals. A good example of such a stable free radical which may act as a mediator is a nitroxide. The stoichiometry between the number of chains mediated and the number of stable free radical molecules, such as a nitroxide, consumed is 1:1.

For example, in a free radical polymerization process mediated by a stable free radical, such as TEMPO, when z′ is very large (>10,000,000,000) there is inhibition and the polymerization process does not proceed. When z′ is very small (<80,000) then there is no mediation and the process proceeds under free radical process kinetics. To act as a mediator (that is, for styrene/TEMPO mediated SFRP process 80,000<z′<10,000,000,000), the coupling process of the stable free radical with the propagating radical must be reversible. Preferably, the range for transition from SFRP to FRP is 200,000<z′<100,000 and more preferably 170,000<z′<130,000. In general, a z′ greater than 150,000 represents SFRP and a z′ value less than 150,000 represents FRP.

For a specific polymerization reaction mixture (that is, monomer(s), solvent, stable free radical, etc.) temperature is a key control parameter for adjusting the equilibrium between coupled (dormant) and uncoupled (living) state. The equilibrium constant K_{SFR} will increase with increasing temperature. Thus, increasing the temperature increases both the propagation rate constant, kₚ (according to the Arrhenius correlation), and the equilibrium constant, K_{SFR}, so that the concentration of propagating radicals will increase:

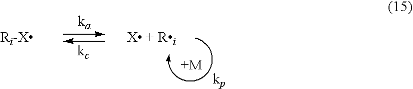

As K_{SFR} and kₚ increase, the value for z′ decreases. Further, because Rₚ is inversely proportional to z′, the polymerization rate increases.

Due to the mediation qualities of a stable free radical, the polymerization rate or kinetics for a stable free radical polymerization process is magnitudes slower than the polymerization rate or kinetics for a free radical polymerization process; this fact accounts for the lack of commercial success of the various conventional stable free radical processes.

In one embodiment, the present invention is a multi stage radical polymerization process comprising at least one SFRP stage and at least one FRP stage:

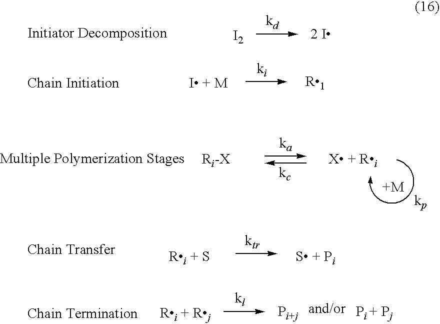

For example, a two polymerization stage process comprising a first SFRP stage (1^{st} polymerization stage where 150,000<z′<10,000,000,000) followed by a first FRP stage (2^{nd} polymerization stage where z′<150,000) can be represented as follows:

1^{st} SFRP Stage→1^{st} FRP Stage (17)

In another embodiment of the present invention, the process comprises more than two polymerization stages, for example three polymerization stages: a first Inhibition stage (1^{st} polymerization stage z′>10,000,000,000) followed by a first SFRP stage (2^{nd} polymerization stage where 150,000<z′<10,000,000,000), and followed by a first FRP stage (3^{rd} polymerization stage where z′<150,000):

1^{st} Inhibition Stage→1^{st} SFRP Stage→1^{st} FRP Stage (18)

In yet another embodiment of the present invention, the process comprises three polymerization stages, different than described hereinabove: a first FRP stage (1^{st} polymerization stage where z′<150,000), followed by a first SFRP stage (2^{nd} polymerization stage where 150,000<z′<10,000,000,000), and followed by a second FRP stage (3^{rd} polymerization stage where z′<150,000):

1^{st} FRP Stage→1^{st} SFRP Stage→2^{nd} FRP Stage (19)

In another embodiment of the present invention, the process comprises four polymerization stages: a first Inhibition stage (1^{st} polymerization stage where z′>10,000,000,000), followed by a first FRP stage (2^{nd} polymerization stage where z′<150,000), followed by a first SFRP stage (3^{rd} polymerization stage where 150,000<z′<10,000,000,000), and followed by a second FRP stage (4^{th} polymerization stage where z′<150,000):

1^{st} Inhibition Stage→1^{st} FRP Stage→1^{st} SFRP Stage→2^{nd} FRP Stage (20)

In the process of the present invention, the switch from a first SFRP stage to a first FRP stage, or visa versa, occurs after the desired degree of (co)monomer conversion and/or one or more process or product property have been achieved in the initial stage. The switch from a SFRP stage to a FRP stage, or visa versa, is not limited to any particular mechanism. In the case where there are two or more SFRP stages (for example, a first SFRP stage and a second SFRP stage) and/or two or more FRP stages (for example, a first FRP stage and a second FRP stage) the switching mechanisms between the different stages may be the same or different.

The mechanism may be via controlling a process parameter, such as changing the temperature, controlling the concentration of the persistent radical [X.], utilizing or sequential adding of comonomers having different kₐ and k_{c} rate constants with the persistent radical, introducing dormant polymer radicals into the process, introducing one or more different persistent radicals, changing the polarity of the polymerization reaction mixture, changing the polymerization reaction pressure, etc.

In one embodiment, an example of controlling a process parameter is changing the temperature between a first stage and a second stage. This would impact the SFR rate constants kₐ and k_{c}. For instance, the first polymerization stage process temperature may be set so that k_{c}>>>>kₐ thereby creating a SFRP process stage. Increasing the temperature would initiate a second polymerization stage so that k_{c}>kₐ thereby creating a FRP process stage:

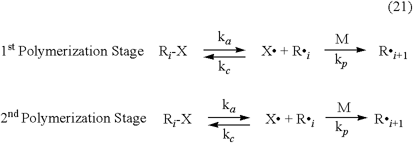

In another embodiment, a mechanism to shift from SFRP stage to a FRP stage is by increasing the concentration of radical chains [R.ᵢ] by controlling the concentration of the persistent radical species [X.]. For example, [X.] may be decreased by the addition of a component, such as a radical trap agent like an alkyl sulfide (for example, R¹SH), to the reaction mixture such that it competes with the reversible reaction which forms Rᵢ-X driving the equilibrium towards a higher [R.ᵢ]. Thus the formation of X—H (and R¹S.) leaving available for FRP:

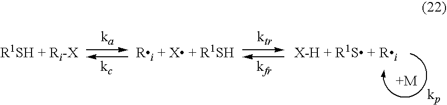

where kₜᵣ corresponds to the rate constant of trapping the persistent radical and k_{fr} corresponds to the rate constant of forming the persistent radical. For a component to be an effective radical trap under the reaction conditions, kₜᵣ>k_{fr}.

In another embodiment, it is possible when the process according to the present invention is a copolymerization, that a first monomer, P, will have a reactivity (k_{cP}>k_{aP}) with Pᵢ-X so as to proceed in the first polymerization stage via a SFRP stage and the addition of a second monomer, Q, having a different reactivity (k_{cQ}<k_{aQ}) with Pₙ-X will switch to the second polymerization stage, PₙQᵢ-X, and proceed via a FRP stage:

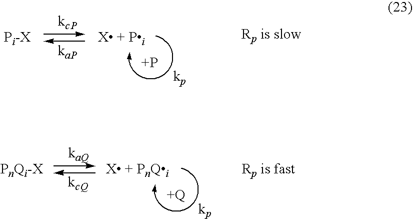

Conversion is defined as the weight of all the solids to the total weight of the reaction mixture, including all additions; conversion is expressed in percent. The partial conversion of (co)monomer to (co)polymer or degree of conversion in the first SFRP stage prior to switching to the first FRP stage is selected so as to provide a final (co)polymer with the desired properties and can be easily determined by one skilled in the art. For example, the partial conversion for the first SFRP stage could be any numerical value between 1 and 99 percent conversion. For example, it can be 1 percent, 2, 3, 4, 5, 10, 15, 20, 25, 30, 35, 40, 45, 50, 55, 60 or the like. Further, the partial conversion for the first SFRP stage can be any range selected between such values, for example, 2 to 5 percent, or 5 to 15 percent, or 10 to 20 percent, or 15 to 30 percent. Suitable degree of conversion for the first FRP stage and any subsequent stages may also be selected from any numerical value equal to or less than 100 percent minus the percent conversion for the first SFRP stage, 100 percent minus (the percent conversion for the first SFRP stage and the percent conversion for the first FRP stage), etc. Suitable ranges for conversion for the first FRP stage can be selected by subtracting the ranges of the percent conversion of the first SFRP stage from 100 percent, for example if the range of partial conversion for the first SFRP stage is between 5 to 20, the range for the conversion of the first FRP stage may be from between 95 to 80 or less. Since conversion of the polymerization reaction need not be 100 percent, the values and/or ranges for conversion of the first SFRP stage, the first FRP stage and any subsequent stages if present need not add up to 100 percent conversion.

Various techniques suitable for producing (co)polymers and preferably rubber-modified (co)polymers such as rubber-modified vinyl aromatic (co)polymers are well known in the art and may be employed in the present invention. Examples of these known polymerization processes include emulsion polymerization process and bulk, mass-solution, or mass-suspension polymerization, generally known as mass polymerization processes. For a good discussion of how to make rubber-modified vinyl aromatic copolymer see “Modern Styrenic Polymers” of Series In Polymer Science (Wiley), Ed. John Scheirs and Duane Priddy, ISBN 0 471 497525. Also, for example, U.S. Pat. Nos. 3,660,535; 3,243,481; and 4,239,863, which are incorporated herein by reference. The reaction process may be continuous polymerization, batch polymerization, tube polymerization, or combinations thereof.

A preferred example of a rubber-modified vinyl aromatic polymer for the process of the present invention is a high impact polystyrene (HIPS) and a preferred example of a rubber-modified vinyl aromatic copolymer is an acrylonitrile, butadiene, and styrene terpolymer (ABS).

In one embodiment, continuous mass polymerization techniques are advantageously employed in preparing the vinyl aromatic (co)polymers of the present invention. Preferably, the polymerization is conducted in one or more substantially linear, stratified flow or so-called “plug-flow” type reactor such as described in U.S. Pat. No. 2,727,884, sometimes referred to as a multizone plug flow bulk process, which may or may not comprise recirculation of a portion of the partially polymerized product or, alternatively, in a stirred tank reactor wherein the contents of the reactor are essentially uniform throughout, which stirred tank reactor is generally employed in combination with one or more plug-flow type reactors. Alternatively, a parallel reactor set-up, as taught in EP 412801, may also be suitable for preparing the rubber-modified monovinylidene aromatic (co)polymer of the present invention.

Multizone plug flow bulk processes include one or more polymerization vessels (or towers) having one or more reaction zones. When more than one reaction vessel is used, the reaction vessels are consecutively connected to each other, providing a series of multiple polymerization vessels each having one or more reaction zones. A monomer, for example a vinyl aromatic monomer such as styrene (ST), optionally one or more comonomer, for example acrylonitrile (AN), optionally a rubber, for example butadiene rubber and optionally a solvent are dissolved in a mixture forming a homogeneous solution. The homogeneous solution is fed into the polymerization reaction system. The polymerization can be thermally or chemically initiated, and viscosity of the reaction mixture will gradually increase. The polymerization process is allowed to continue until the desired degree of (co)monomer to (co)polymer conversion is reached. Removal of unreacted (co)monomer, as well as removal of diluent or solvent, if employed, and other volatile materials is advantageously conducted employing conventional devolatilization techniques, such as introducing the polymerization mixture into a devolatilizing chamber, flashing off the (co)monomer and other volatiles at elevated temperatures, for example, from 170° C. to 300° C. and/or under vacuum and removing them from the chamber. Finally, the (co)polymer is extruded and (co)polymer pellets are obtained from a pelletizer.

During the course of the reaction the rubber, when present, will be grafted with the (co)monomer. At a point where the free (co)polymer (that is non-grafted (co)polymer) can not be “held” in one single phase, it begins to form discrete domains, consisting of (co)polymer dissolved in a continuous (co)monomer/solvent mixture in the continuous rubber phase (this is sometimes referred to as phase separation). The polymerization mixture is now a two-phase system with free (co)polymer being the discontinuous phase. This is considered an oil-in-oil emulsion system. As polymerization proceeds, more and more free (co)polymer is formed increasing the discontinuous phase volume. At a certain point in time both phases (rubber and free (co)polymer) have the same phase volume. At this stage, the system can be referred to as co-continuous. As further polymerization takes place the free (co)polymer phase increases in volume and becomes the continuous phase while the rubber phase becomes the discontinuous phase. The rubber phase starts to disperse itself as particles (rubber domains) in the matrix of the ever-growing free (co)polymer continuous phase (this is sometimes referred to as phase inversion). During this process, free (co)polymer can become trapped inside the rubber particles as they are formed; this is referred to as occlusions. Pre-phase inversion means that the phase comprising the rubber is the continuous phase and that rubber particles have not yet formed. Post-phase inversion means that substantially all of the phase comprising the rubber has been converted to rubber particles which is initially (co)continuous with the (co)polymer phase. Following phase inversion, the (co)polymer phase becomes the continuous phase as more matrix (co)polymer (free (co)polymer) is formed; the rubber particles may gain more grafted (co)polymer.

A feed with an additional monomer, for example N-phenyl maleimide which increases the glass transition temperature (Tg) of the matrix and also the heat resistance of the product, can be added in one or more location throughout the polymerization process. The location(s) may be the same or different from where the (co)monomers are added, for example see U.S. Pat. Nos. 5,412,036 and 5,446,103, which are incorporated herein by reference.

When a desirable (co)monomer conversion level and a matrix (co)polymer of desired molecular weight distribution is obtained, the polymerization mixture is then subjected to conditions sufficient to cross-link the rubber and remove any unreacted (co)monomer. Such cross-linking and removal of unreacted (co)monomer, as well as removal of diluent or solvent, if employed, and other volatile materials is advantageously conducted employing conventional devolatilization techniques, such as introducing the polymerization mixture into a devolatilizing chamber, flashing off the (co)monomer and other volatiles at elevated temperatures, for example, from 170° C. to 300° C. and/or under vacuum and removing them from the chamber. Finally, the rubber-modified (co)polymer is extruded and rubber-modified (co)polymer pellets are obtained from a pelletizer.

The temperatures at which polymerization is most advantageously conducted in the present invention are dependent on a variety of factors including, but not limited to, the type and amount of stable free radical, the type and amount of initiator(s), the type and concentration of rubber(s), type and amount of (co)monomer(s), reactor set-up (for example, linear, parallel, recirculation, etc.), and reaction solvent, if any, employed. Polymerization is continued until the desired conversion of (co)monomer(s) to (co)polymer is obtained. Generally, conversion of from 55 to 90, preferably 60 to 85 percent is desired.

To synthesize rubber-modified vinyl aromatic (co)polymer with high performance by the mass process, four aspects are essential among many others. These aspects are grafting of the rubber substrate prior to phase inversion, particle formation or sizing after phase inversion, building molecular weight and molecular weight distribution of the matrix, and cross-linking of the rubber particle at the completion point of the mass polymerization.

Alternatively, a combination of mass and suspension polymerization techniques are employed. Using said techniques, following phase inversion and subsequent size stabilization of the rubber particles, the partially polymerized product can be suspended with or without additional (co)monomers in an aqueous medium which contains one or more initiator and polymerization is subsequently completed. The rubber-modified monovinylidene vinyl (co)polymer is subsequently separated from the aqueous medium by acidification, centrifugation or filtration. The recovered product is then washed with water and dried.

By the term monomer we mean any polymerizable or copolymerizable monomer by the radical process, in other words a monomer with one or more unsaturated bond. The monomer can be selected from among vinylidene monomers, diene monomers, olefinic monomers, allylic monomers, vinyl monomers, and mixtures thereof.

Suitable vinylidene monomers are vinylidene fluoride and vinylidene chloride.

Suitable diene monomers can be selected from among linear or cyclic dienes, conjugated or non-conjugated such as butadiene, 2,3-dimethyl butadiene, isoprene, 1,3-pentadiene, 1,4-pentadiene, 1,4-hexadiene, 1,5-hexadiene, 1,9-decadiene, 5-methylene-2-norbornene, 5-vinyl-2-norbornene, 2-alkyl-2,5-norbonadienes, 5-ethylene-2-norbornene, 5-(2-propenyl)-2-norbornene, 5-(5-hexenyl)-2-norbornene, 1,5-cyclooctadiene, bicyclo[2,2,2]octa-2,5-diene, cyclopentadiene, 4,7,8,9-tetrahydroindene and isopropylidene tetrahydroindene.

Suitable olefinic monomers include ethylene, propylene, butene, hexene and 1-octene. Halogenated olefinic monomers are also suitable; examples of halogenated olefinic monomers are vinylchloride, vinylfluoride, and tetrafluoroethylene.

By vinyl monomers we mean (meth)acrylates, vinyl aromatic monomers, vinyl esters, unsaturated nitriles, (meth)acrylamide, mono- and di-(alkyl C₁-C₁₈)-(meth)acrylamides, the monoesters and diesters of maleic anhydride, maleic acid, and fumaric acid, and unsaturated anhydrides and imides having a double bond.

Preferred vinyl esters include vinyl acetate and vinyl propionate.

Preferred unsaturated nitriles include acrylonitrile, methacrylonitrile, ethacrylonitrile, and fumaronitrile.

Preferred esters of maleic acid are dimethyl maleate, diethyl maleate and dibutyl maleate.

Preferred esters of fumaric acid are dimethyl fumarate, diethyl fumarate and dibutyl fumarate,

A preferred unsaturated anhydride is maleic anhydride

A preferred unsaturated imide is N-phenyl maleimide

The (meth)acrylates are particularly those with the following formulas:

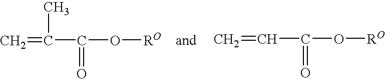

where R^{o} is selected from among C₁-C₁₈ linear or branched alkyl groups, primary, secondary or tertiary, C₅-C₁₈ cycloalkyl, (alkoxy C₁-C₁₈)-alkyl C₁-C₁₈, (alkylthio C₁-C₁₈)-alkyl C₁-C₁₈, aryl and arylalkyl, these groups are optionally substituted by at least one halogen atom and/or at least one hydroxyl group and for ester of this hydroxyl group with the abovementioned branched or linear alkyl groups; and (meth)acrylate, glycidyl, norbonyl or isobornyl.

Suitable examples of methacrylates include methyl methacrylate, ethyl methacrylate, 2,2,2-trifluorethyl methacrylate, n-propyl methacrylate, isopropyl methacrylate, n-butylmethacrylate, s-butyl methacrylate, t-butylmethacrylate, n-amyl methacrylate, di-amylmethacrylate, n-hexylmethacrylate, 2-ethylhexylmethacrylate, cyclohexylmethacrylate, octylmethacrylate, i-octylmethacrylate, nonylmethacrylate, decylmethacrylate, laurylmethacrylate, stearylmethacrylate, phenylmethacrylate, benzylmethacrylate, β-hydroxy-ethylmethacrylate, bornyl methacrylate, hydroxypropyl methacrylate, and hydroxybutyl methacrylate.

Suitable examples of the acrylates of the above formula include methyl acrylates, ethyl acrylates, n-propyl acrylates, isopropyl acrylates, n-butyl acrylates, s-butyl acrylates, hexyl acrylates, 2-ethylhexylacrylates, isooctylacrylates, 3,3,5-trimethylhexylacrylates, nonylacrylates, decylacrylates, laurylacrylates, octadecylacrylates, cyclohexylacrylates, phenylacrylates, methoxymethylacrylates, methoxyethylacrylates, ethoxymethylacrylates and ethoxyethylacrylates.

Suitable examples of vinyl esters include vinyl acetate, vinyl propionate, vinyl chloride and vinyl fluoride.

By vinyl aromatic monomer according to the invention we mean an aromatic monomer with ethylenic unsaturation which include, but are not limited to those described in U.S. Pat. Nos. 4,666,987; 4,572,819 and 4,585,825, which are herein incorporated by reference. Preferably, the monomer is of the formula:

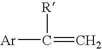

wherein R. is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Preferred monovinylidene aromatic monomers include: styrene, alpha-methylstyrene, all isomers of vinyl toluene, especially paravinyltoluene, all isomers of ethyl styrene, propyl styrene, vinyl biphenyl, vinyl naphthalene, vinyl anthracene, and mixtures thereof.

A vinyl monomer may be copolymerized with one or more comonomer. A copolymer is herein defined a polymer comprising two or more comonomers; for example the copolymer may comprise two comonomers, three comonomers, four comonomers, etc. Suitable comonomer(s) can be selected from any of the monomers listed hereinabove as long as selected vinyl monomer will copolymerize with the selected comonomer. Typically, the vinyl monomer will constitute from an amount equal to or greater than about 5 weight percent, preferably from an amount equal to or greater than about 20 weight percent, more preferably from an amount equal to or greater than about 30 weight percent, and most preferably from an amount equal to or greater than about 40 weight percent based on the total weight of the copolymer. Typically, if the vinyl monomer is copolymerized with one or more comonomer, it will constitute less than or equal to about 95 weight percent, preferably less than or equal to about 80 weight percent, more preferably less than or equal to about 70 weight percent, and most preferably less than or equal to about 60 weight percent based on the total weight of the copolymer. A preferable vinyl monomer for copolymerization is a vinyl aromatic monomer. A most preferable vinyl monomer for copolymerization is (alpha methyl)styrene.

One or more comonomer is independently employed in the copolymer in an amount equal to or greater than about 5 weight percent, preferably in an amount equal to or greater than about 10 weight percent, more preferably in an amount equal to or greater than about 15 weight percent, and most preferably in an amount equal to or greater than about 20 weight percent based on the total weight of the copolymer. One or more comonomer is independently employed in the copolymer in an amount less than or equal to about 50 weight percent, preferably equal to or less than about 45 weight percent, more preferably less than or equal to about 35 weight percent, and most preferably less than or equal to about 30 weight percent based on the total weight of the copolymer.

When the vinyl monomer for copolymerization is a vinyl aromatic monomer a preferable comonomer is an unsaturated nitrile. When the vinyl monomer for copolymerization is (alpha methyl)styrene the most preferable comonomer is (meth)acrylonitrile. Other vinyl monomers may also be included in polymerized form in a vinyl aromatic monomer/unsaturated nitrile copolymer include: conjugated 1,3 dienes (for example butadiene, isoprene, etc.); alpha- or beta-unsaturated monobasic acids and derivatives thereof (for example, acrylic acid, methacrylic acid, etc., and the corresponding esters thereof such as methylacrylate, ethylacrylate, n-butyl acrylate, iso-butyl acrylate, methyl methacrylate, etc.); vinyl halides such as vinyl chloride, vinyl bromide, etc.; vinylidene chloride, vinylidene bromide, etc.; vinyl esters such as vinyl acetate, vinyl propionate, etc.; ethylenically unsaturated dicarboxylic acids and anhydrides and derivatives thereof, such as maleic acid, fumaric acid, maleic anhydride, dialkyl maleates or fumarates, such as dimethyl maleate, diethyl maleate, dibutyl maleate, the corresponding fumarates, N-phenyl maleimide (NPMI), etc. These additional comonomers can be incorporated in to the composition in several ways including, interpolymerization with the vinyl aromatic monomer/unsaturated nitrile matrix copolymer and/or polymerization into polymeric components which can be combined, for example blended in to the matrix. If present, the amount of such comonomers will generally be equal to or less than about 30 weight percent, more preferably equal to or less than about 20 weight percent, more preferably equal to or less than about 10 weight percent, and most preferably less than or equal to about 5 weight percent based on the total weight of the vinyl aromatic monomer/unsaturated nitrile matrix copolymer.

When the product of the process of the present invention is a rubber-modified vinyl aromatic (co)polymer the matrix (co)polymer is present in an amount equal to or greater than about 60 weight percent, preferably equal to or greater than about 70 weight percent, more preferably equal to or greater than about 75 weight percent, even more preferably equal to or greater than about 80 weight percent and most preferably equal to or greater than about 82 weight percent based on the weight of the rubber-modified vinyl aromatic (co)polymer. The matrix (co)polymer is present in an amount equal to or less than about 95 weight percent, preferably equal to or less than about 90 weight percent, more preferably equal to or less than about 85 weight percent based on the weight of the rubber-modified vinyl aromatic (co)polymer.

The process of the present invention makes possible the preparation of block copolymers. In fact, the polymerization of a first monomer by the method according to the invention results in a live (active) block polymer. It is then possible to attach to this first block, a block of another polymer by placing the first live polymer block in a polymerization medium of a second monomer. It is thus possible to produce block copolymers, for example copolymers comprising one or several blocks of polystyrene and one or several blocks of polybutadiene or copolymers comprising one or several blocks of polystyrene and one or several blocks of a methylacrylate.

It is understood that it is possible to attach as many blocks as is desired to the live polymer by placing said polymer inside a polymerization medium of a given monomer to constitute said blocks.

In this manner, the invention concerns a method for the preparation of a block polymer comprising at least one step of the invention resulting in a first live block, said live block then being placed in the presence of at least one other monomer of the desired material to constitute the block that shall be attached to the first block in order to form a live diblock and so on in this manner until achieving the desired number of blocks.

In this manner, the invention also concerns a method for the preparation of a diblock polymer comprising a polymerization step for a first monomer according to the invention in order to obtain a first live block following a step during which the first live block is placed in the presence of a second monomer that is polymerized in order to form a second block attached to the first block.

This invention also concerns a method for the preparation of a triblock polymer comprising a polymerization step of a third monomer in the presence of a diblock polymer prepared according to the procedure described above in order to form a third block to attach to the diblock.

The formation of each block can be carried out at a different temperature; however, between the formation of two blocks, it is preferable not to lower the temperature of the reaction medium to a temperature below the lowest temperature used for the formation of each of the two blocks. Preferably, the temperature of the medium is maintained at least 100° C. during all the block formation processes. That is, during the formation of the blocks and also during the time in between the formation.

The following are examples of block polymers which can be made by the process of the present invention: polystyrene-b-methyl polymethacrylate, polystyrene-b-polystyrenesulfonate, polystyrene-b-polyacrylamide, polystyrene-b-polymethacrylamide, methyl polymethacrylate-b-ethyl polyacrylate, polystyrene-b-butyl polyacrylate, polybutadiene-b-methyl polymethacrylate, polyisoprene-b-polystyrene-co-acrylonitrile, polystyrene-co-acrylonitrile-b-polystyrene-co-acrylonitrile, polybutadiene-b-polystyrene-co-acrylonitrile, polystyrene-co-butyl acrylate-b-methyl polymethacrylate, polystyrene-b-vinyl polyacetate, polystyrene-b-2-hexylethyl polyacrylate, polystyrene-b-methyl polymethacrylate-co-hydroxyethyl acrylate, polystyrene-b-polybutadiene-b-methyl polymethacrylate, polybutadiene-b-polystyrene-b-methyl polymethacrylate, polystyrene-b-butyl polyacrylate-b-polystyrene, and polystyrene-b-polyisoprene-b-polystyrene. A preferred block copolymer is polystyrene-b-polybutadiene-b-polystyrene.

The process of the present invention allows for the preparation of grafted polymers with (co)polymers or block (co)polymer grafts. The polymerization of a monomer in the presence of a stable free radical and a macro-polymerization initiator produces a live polymer block grafted on the initial macro-polymer initiator chain. A macro-polymer initiator is a polymer comprising at least one atom capable of forming a stable free radical under the polymerization conditions of the graft (co)polymer or block (co)polymer. The stable free radical thus formed is capable of initiating polymerization of the (co)monomer which forms the graft (co)polymer or block (co)polymer. These types of macroinitiators are described in French patent application number FR 9713383. For example, a microinitiator may be an oligomer or a polymer prepared in the presence of a nitroxyl radical or a nitroxylether or by grafting of an existing conventionally polymerized polymer with a nitroxylether or a nitroxide radical as described in EP 1115766 or EP 1115765 and having attached to the oligomer/polymer backbone a nitroxyl group with the structural element:

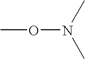

The polymerization process to prepare the macroinitiator may be anionic, radical, or combinations thereof.

The grafted (co)polymer or block formed in this manner is live because it presents on its extremity a group capable of generating the stable free radical. In this manner it is possible to attach to this first block a second block by placing the polymer grafted by the first block in the presence of another monomer in order to polymerize the latter at the end of the first block. Upon the formation of the second block, the polymer appears grafted by a diblock copolymer and has on its end a group capable of generating the stable free radical.

It is understood that it is possible to attach as many blocks as desired to the live polymer by placing it in a polymerization medium with the monomer desired to constitute the next block.

Thus, the invention also concerns a method for the preparation of a grafted polymer comprising at least one step according to the invention resulting in a polymer grafted by a first live block, said live block is then placed in the presence of at least another monomer when it is desirable to attach another block to the first block in order to form a polymer grafted by a live diblock and so on until the desired number of blocks are grafted on.

The formation of each block can be accomplished at different temperatures. However, between the formation of two blocks, it is preferable not to lower the temperature of the medium to a temperature below the lowest temperature used for the formation of each of the two blocks. Preferably, the temperature of the medium is maintained at least 100° C. over the entire block formation process, that is during the formation of the blocks as well as the time between their formation process.

The following copolymers are examples of the grafted copolymers that can be obtained: polyethylene-g-polystyrene, polyethylene-g-methyl polymethacrylate, polyethylene-g-poly(styrene-co-acrylonitrile), polyethylene-g-poly(styrene-co-hydroxyethyl acrylate), polyethylene-g-(polystyrene-b-methyl polymethacrylate), polypropylene-g-polystyrene, polypropylene-g-methyl polymethacrylate, polypropylene-g-poly(styrene-co-acrylonitrile), polypropylene-g-(polystyrene-b-methyl polymethacrylate), poly(ethylene-co-glycidylmethacrylate)-g-polystyrene, poly(styrene-co-acrylonitrile), polypropylene-g-(polystyrene-b-methyl polymethacrylate), poly(ethylene-co-glycidylmethacrylate)-1-polystyrene, poly(ethylene-co-glycidylmethacrylate)-g-methyl polymethacrylate, poly(ethylene-co-glycidylmethacrylate)-g-poly(styrene-co-acrylonitrile), poly(ethylene-co-ethylacrylate)-g-polystyrene, poly(ethylene-co-ethylacrylate)-g-methyl polymethacrylate, poly(ethylene-co-ethylacrylate)-g-poly(styrene-co-acrylonitrile), poly(ethylene-co-vinylacetate)-g-polystyrene, poly(ethylene-co-ethylacrylate)-g-methyl polymethacrylate, poly(ethylene-co-ethylacrylate)-g-poly(styrene-co-acrylonitrile), poly(ethylene-co-ethylacrylate-co-maleic anhydride)-g-polystyrene, poly(ethylene-co-ethylacrylate-co-maleic anhydride)-g-methyl polymethacrylate, poly(ethylene-co-ethylacrylate-co-maleic anhydride)-g-poly(styrene-co-acrylonitrile), poly(ethylene-co-butylacrylate)-g-polystyrene, poly(ethylene-co-butylacrylate)-g-methyl polymethacrylate, poly(ethylene-co-butylacrylate)-g-poly(styrene-co-acrylonitrile), poly(ethylene-co-ethylacrylate-co-glycidylmethacrylate-g-polystyrene, poly(ethylene-co-ethylacrylate-co-glycidylmethacrylate)-g-methyl polymethacrylate, poly(ethylene-co-ethylacrylate-co-glycidylmethacrylate)-g-poly(styrene-co-acrylonitrile), polycarbonate-g-polystyrene, polycarbonate-g-methyl polymethacrylate, and polycarbonate-g-poly(styrene-co-acrylonitrile).

The process of the present invention may be used to make rubber-modified (co)polymers. Various rubbers are suitable for use in the present invention. The rubbers include diene rubbers, ethylene propylene rubbers, ethylene propylene diene (EPDM) rubbers, ethylene copolymer rubbers, acrylate rubbers, polyisoprene rubbers, halogen containing rubbers, and mixtures thereof. Also suitable are interpolymers of rubber-forming monomers with other copolymerizable monomers.

Preferred rubbers are diene rubbers such as polybutadiene, polyisoprene, polypiperylene, and polychloroprene, or mixtures of diene rubbers, that is, any rubbery polymers of one or more conjugated 1,3-dienes, with 1,3-butadiene being especially preferred. Such rubbers include homopolymers and copolymers of 1,3-butadiene with one or more copolymerizable monomers, such as monovinylidene aromatic monomers as described hereinabove, styrene being preferred. Preferred copolymers of 1,3-butadiene are block or tapered block rubbers of at least about 30 weight percent 1,3-butadiene based rubber, more preferably from about 50 weight percent, even more preferably from about 70 weight percent, and most preferably from about 90 weight percent 1,3-butadiene based rubber and up to about 70 weight percent monovinylidene aromatic monomer, more preferably up to about 50 weight percent, even more preferably up to about 30 weight percent, and most preferably up to about 10 weight percent monovinylidene aromatic monomer, weights based on the weight of the 1,3-butadiene based copolymer.

Linear block copolymers can be represented by one of the following general formulas:

S-B;

S₁-B-S₂;

B₁-S₁-B₂-S₂;

In which S, S₁, and S₂ are non-elastic polymer blocks of a monovinylidene aromatic monomer, with equal or different molecular weights and B, B₁, and B₂ are elastomeric polymer blocks based on a conjugated diene, with equal or different molecular weights. In these linear block copolymers, the non-elastic polymer blocks have a molecular weight of between 5,000 and 250,000 and the elastomeric polymer blocks have a molecular weight of between 2,000 and 250,000. Tapered portions can be present among the polymer blocks, S, S₁, and S₂ and B, B₁, and B₂. In the tapered portion the passage between the blocks B, B₁, and B₂ and S, S₁, and S₂ can be gradual in the sense that the proportion of monovinylidene aromatic monomer in the diene polymer increases progressively in the direction of the non-elastomeric polymer block, whereas the portion of conjugated diene progressively decreases. The molecular weight of the tapered portions is preferably between 500 and 30,000. These linear block copolymers are described for example in U.S. Pat. No. 3,265,765 and can be prepared by methods well known in the art. Further details on the physical and structural characteristics of these copolymers are given in B. C. Allport et al. “Block Copolymers”, Applied Science Publishers Ltd., 1973.

The rubbers preferably employed in the practice of the present invention are those polymers and copolymers which exhibit a second order transition temperature, sometimes referred to as the glass transition temperature (Tg), for the diene fragment which is equal to or less than 10° C., preferably equal to or less than 0° C., more preferably equal to or less than −10° C., and more preferably less than or equal to −20° C. as determined using conventional techniques, for example ASTM Test Method D 746-52 T. Tg is the temperature or temperature range at which a polymeric material shows an abrupt change in its physical properties, including, for example, mechanical strength. Tg can be determined by differential scanning calorimetry (DSC).

The rubber in the rubber-modified (co)polymer of the present invention is present in an amount equal to or greater than about 3 weight percent, preferably equal to or greater than about 5 weight percent, more preferably equal to or greater than about 7 weight percent, more preferably equal to or greater than 9.5 weight percent, more preferably equal to or greater than about 10 weight percent, more preferably equal to or greater than about 11 weight percent, and even more preferably equal to or greater than about 12 weight percent based on the weight of the rubber-modified (co)polymer. The rubber in the rubber-modified (co)polymer of the present invention is present in an amount equal to or less than about 40 weight percent, preferably equal to or less than about 30 weight percent, more preferably equal to or less than about 25 weight percent, even more preferably equal to or less than about 20 weight percent, and most preferably equal to or less than about 18 weight percent based on the weight of the rubber-modified (co)polymer.

Preferred structures for the rubber dispersed in the matrix (co)polymer are one or more branched rubber, one or more linear rubber or combinations thereof. Branched rubbers, as well as methods for their preparation, are known in the art. Representative branched rubbers and methods for their preparation are described in Great Britain U.S. Pat. No. 1,130,485 and in Macromolecules, Vol. II, No. 5, pg. 8, by R. N. Young and C. J. Fetters.

In one embodiment, the rubber is a radial or star-branched polymer, commonly referred to as polymers having designed branching. Star-branched rubbers are conventionally prepared using a polyfunctional coupling agent or a polyfunctional initiator and have three or more polymer segments sometimes referred to as arms, preferably between three to eight arms, bonded to a single polyfunctional element or compound.

The arms of the star-branched rubber are preferably one or more 1,3 butadiene based rubber, more preferably they are all the same type of 1,3 butadiene based rubber, that is, 1,3 butadiene based tapered block copolymer(s), 1,3 butadiene based block copolymer(s) or 1,3-butadiene homopolymer(s) or a combination thereof.

Methods for preparing star-branched or radial polymers having designed branching are well known in the art. Methods for preparing a polymer of butadiene using a coupling agent are illustrated in U.S. Pat. Nos. 4,183,877; 4,340,690; 4,340,691 and 3,668,162, whereas methods for preparing a polymer of butadiene using a polyfunctional initiator are described in U.S. Pat. Nos. 4,182,818; 4,264,749; 3,668,263 and 3,787,510, all of which are herein incorporated by reference. Other star-branched rubbers useful in the composition of the present invention include those taught in U.S. Pat. No. 3,280,084 and U.S. Pat. No. 3,281,383, which are incorporated herein by reference.

Linear rubbers, as well as methods for their preparation, are well known in the art. The term “linear rubber” refers to straight chains of polymerized monomer or comonomers which include uncoupled and dicoupled rubber wherein one or two polymeric segments or arms have been attached to a multifunctional coupling agent. The rubber polymer segments in a dicoupled linear rubber can be the same type, that is, both 1,3-butadiene homopolymers, more preferably 1,3-butadiene taper block copolymers, and most preferably 1,3-butadiene block copolymers, or they can be different, for example, one rubber polymer segment can be a 1,3-butadiene homopolymer and the other polymer segment a 1,3-butadiene block copolymer. Preferably, the linear rubber is one or more 1,3-butadiene homopolymer, more preferably one or more 1,3-butadiene tapered block copolymer, most preferably one or more 1,3-butadiene block copolymer or combinations thereof. The preferred comonomers comprising the tapered block copolymer and/or block copolymer linear rubber are styrene and butadiene.

Preferably a diene rubber used in the invention has a cis content equal to or less than 99 percent and preferably equal to or less than 97 percent. Preferably the cis content of the diene rubber will be equal to or greater than 20 percent and preferably equal to or greater than 37 percent wherein the cis weight percent is based on the weight of the diene rubber.

A preferred rubber is a 1,3-butadiene based polymer having at least about 1 weight percent 1,2-vinyl and more preferably at least about 7 weight percent 1,2-vinyl based on the weight of the 1,3-butadiene based rubber. Preferably the 1,3-butadiene based rubber has less than or equal to about 30 weight percent 1,2-vinyl and more preferably less than or equal to about 13 weight percent 1,2-vinyl based on the weight of the 1,3-butadiene based rubber.

A preferred rubber is a diene rubber having a weight average molecular weight of at least about 1 kilogram per mole (kg/mole), preferably at least about 100 kg/mole and more preferably having a weight average molecular weight of at least about a 200 kg/mole. Preferably the diene rubber has a weight-average molecular weight equal to or less than about 900 kg/mole and more preferably a weight average molecular weight equal to or less than 600 kg/mole.

A preferred rubber is a diene rubber having a solution viscosity of at least 10 centi Stokes (cst) (10 percent (%) solution in styrene) and more preferably a solution viscosity of about 20 cst. Preferably the diene rubber has a solution viscosity equal to or less than about 500 cst and more preferably equal to or less than about 400 cst.

The rubber, with graft and/or occluded polymers if present, is dispersed in the continuous matrix phase as discrete particles. The rubber particles may comprise a range of sizes having a mono-modal, bimodal, or multimodal distribution. The average particle size of a rubber particle, as used herein, will, refer to the volume average diameter. In most cases, the volume average diameter of a group of particles is the same as the weight average. The average particle diameter measurement generally includes the polymer grafted to the rubber particles and occlusions of polymer within the particles.

Rubber particle size may be determined by image analysis of transmission electron micrographs (TEMs). Alternatively, rubber particle size may be determined by a Coulter Counter method. The preferred Coulter Counter volume average particle size of the rubber particles is equal to or greater than about 0.5 micrometer (μm), preferably equal to or greater than about 0.7 μm, more preferably equal to or greater than about 1.0 μm more preferably equal to or greater than about 1.25 μm, more preferably equal to or greater than about 1.5 μm, and most preferably equal to or greater than about 1.6 μm. The average particle size of the rubber particles is equal to or less than about 6 μm, preferably equal to or less than about 5 μm, more preferably equal to or less than about 4 μm, more preferably equal to or less than about 3 μm, and more preferably equal to or less than about 2 μm.

Rubber cross-linking is quantified by the light absorbance ratio (LAR). In the rubber-modified copolymer of the present invention, it is preferred that the rubber particles have a light absorbance ratio preferably equal to or greater than about 0.1, more preferably equal to or greater than about 0.2, and most preferably equal to or greater than about 0.3. The preferred light absorbance ratio of the dispersed phase is less than or equal to about 0.9, preferably less than or equal to about 0.8, more preferably less than or equal to about 0.7, and most preferably less than or equal to 0.6. Light absorbance ratio is the ratio of light absorbance for a suspension of the rubber particles in dimethylformamide to the light absorbance for a suspension of the rubber particles in dichloromethane, as described in the examples hereinbelow.

The light absorbance ratio, which is a measure for degree of cross linking, is dependent on the amount and kind of the polymerization initiator and the temperature and the residence time at the removal step for the volatile components. It also depends on the types and amounts of the matrix monomers, antioxidant, chain transfer agent, etc. A suitable light absorbance ratio can be set by a person skilled in the art by choosing the appropriate conditions for the production process in accordance with the trial and error method.

It should be noted that the notion of a stable free radical is known to someone skilled in the art to designate a persistent radical and one that is unreactive towards air and humidity in the ambient air, that the pure radical can be handled and stored without having to take special precautions at room temperature as are most commercial chemical products (see D. Griller and K. Ingold, Accounts of Chemical Research, 1976, 9, 13-19, or Organic Chemistry of Stable Free Radicals, A. Forrester and coll., Academic Press, 1968).

The following structures of radicals are examples of stable free radicals that can be used:

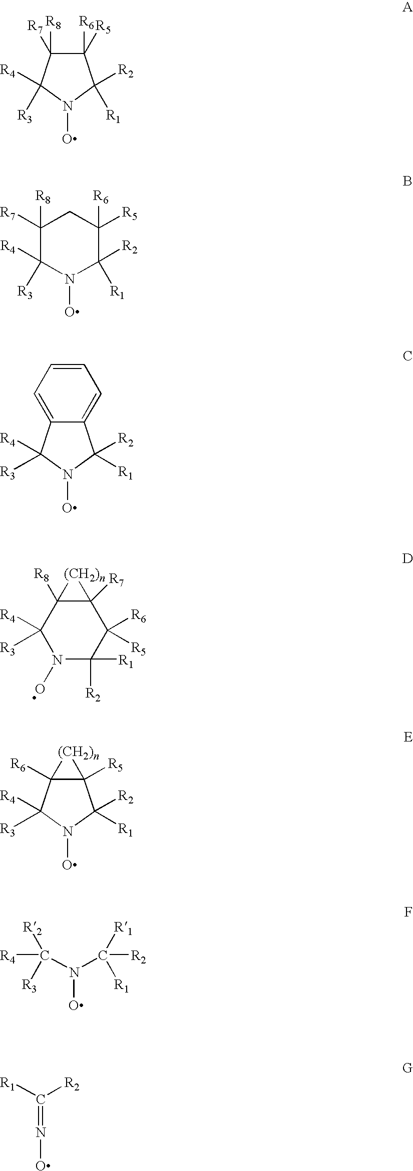

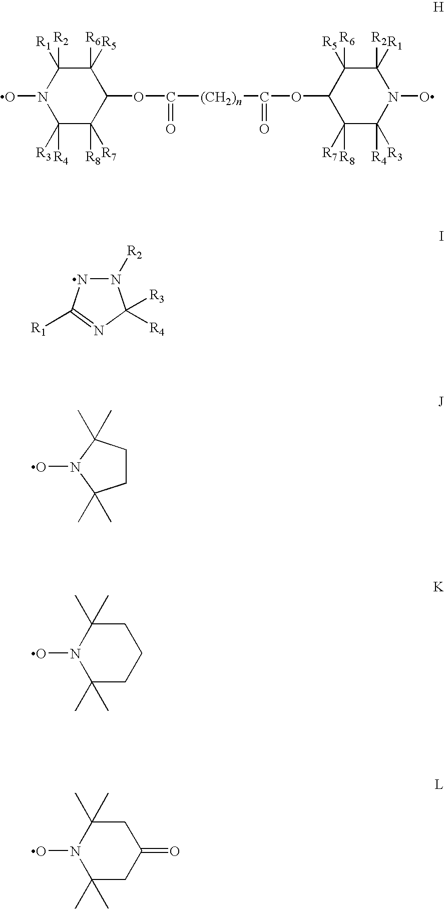

where n represents a whole number other than zero and R₁, R₂, R₃, R₄, R′ᵢ and R′₂ can be identical or different and represent a halogen atom such as chlorine, bromine or iodine, a linear hydrocarbon group, branched or cyclic, saturated or unsaturated such as phenyl or an alkyl radical, or an ester group —COOR or an alkyl —OR, or a phosphonate group —PO(OR)₂, or a polymer chain that could be for example a methylpolymethacrylate chain, a polybutadiene chain, a polyolefin such as polyethylene or polypropylene but preferably being a polystyrene chain where R5, R6, R7, R8, R9 and R10, can be identical or different and can be selected from the same family of the groups as are represented by R1, R2, R3, R4, R′1 and R′2 and additionally could represent a hydrogen atom, a hydroxide group —OH, an acid such as —COOH or —PO(OH)₂ or —SO₃H.

Alternatively one can add to a polymerization process a substituent that creates stable free radical species upon reaction with peroxide initiator decomposition products. An example of such chemistry are the nitrones, that generate stable nitroxide radicals that comprise the ═N—O. group. A more specific example is N-tert-butyl-alpha-isopropylnitrone. This compound has been described in Macromolecules, Detrembleur et. al, 2002, 35, pp. 7214-7223.

A preferable family of stable free radicals includes stable nitroxide radicals, that is, they comprise the ═N—O. group. Preferably, the stable free radical is 2,2,5,5-tetramethyl-1-pyrrolidinyloxy, sold under the trade name PROXYL J, 2,2,6,6-tetramethyl-1-piperidinyloxy, generally sold as TEMPO K or 4-oxo-2,2,6,6-tetramethyl piperidine-1-oxyl, generally sold as OXO-TEMPO or O-TEMPO L.

The stable free radical can also be selected from the following list: N-tertiobutyl-1-phenyl-2 methyl propyl nitroxide, N-tertiobutyl-1-(2-naphtyl)-2-methyl propyl nitroxide, N-tertiobutyl-1-diethylphosphono-2,2-dimethyl propyl nitroxide, N-tertiobutyl-1-dibenzylphosphono-2,2-dimethyl propyl nitroxide, N-phenyl-1-diethyl phosphono-2,2-dimethyl propyl nitroxide, N-phenyl-1-diethyl phosphono-1-methyl ethyl nitroxide, N-(1-phenyl-2-methyl propyl)-1-diethylphosphono-1-methyl ethyl nitroxide, 4-hydroxy-2,2,6,6-tetramethyl-1-piperidinyloxy, 4-oxo-2,2,6,6-tetramethyl-1-piperidinyloxy, and 2,4,6-tri-tert-butylphenoxy.

It is well understood that the scope of the patent also includes the introduction of a chemical entity that behaves as an initiator or a free radical generator under predetermined polymerization conditions, but may be stable under other polymerization conditions, for example, a product which is not, or does not generate, a stable free radical at room temperature but which is a source of stable free radicals and active free radical entities from the time the polymerization temperature reaches a predetermined temperature. Such compositions, comprising ═N—O—X groups are described in U.S. Pat. No. 4,581,429 and Kinetics Of Living Radical Polymerization, Goto, A. and Fukuda, T., Prog. Polymer Science, 29, 2004, pp. 329-385. Such compounds generate stable free radicals and active free radical entities at the typical polymerization temperatures and comprise a ═N—O. group. The —X group may comprise a low molecular weight chemical entity, or oligomeric, or polymeric entity providing product or process added value/differentiation. Compositions comprising ═N—O—X groups can be generated in a separate process potentially utilizing chemistry other than (stable free) radical chemistry.

The following are a few examples of such ═N—O—X compositions wherein the —X groups are cyclic hydrocarbon groups, substituted or unsubstituted with one or more methyl groups, ═O, and/or —OH: Piperidine, 2,2,6,6-tetramethyl-1-(1-methyl-1-phenylethoxy)-(9Cl) M; Piperidine, 2,2,6,6-tetramethyl-1-(1-phenylethoxy)-(9Cl) N; Piperidine, 1-[2-(1,1-dimethylethoxy)-1-phenylethoxy]-2,2,6,6-tetramethyl-(9Cl) O; 4-Piperidinone, 1-(1,1-diphenylethoxy)-2,2,6,6-tetramethyl-(9Cl) P; Propanenitrile, 2-methyl-2-[(2,2,6,6-tetramethyl-4-oxo-1-piperidinyl)oxy]-(9Cl) Q; Benzeneethanol, b-[(2,2,6,6-tetramethyl-1-piperidinyl)oxy]-, benzoate (ester) (9Cl) R; Piperidine, 1-(1,1-dimethylethoxy)-2,2,6,6-tetramethyl-(9Cl) S; 4-Piperidinol-1-15N,2,2,6,6-tetramethyl-1-(1-phenylethoxy)-(9Cl) T; and 4-Piperidinone, 2,2,6,6-tetramethyl-1-(1-phenylethoxy)-(9Cl) U:

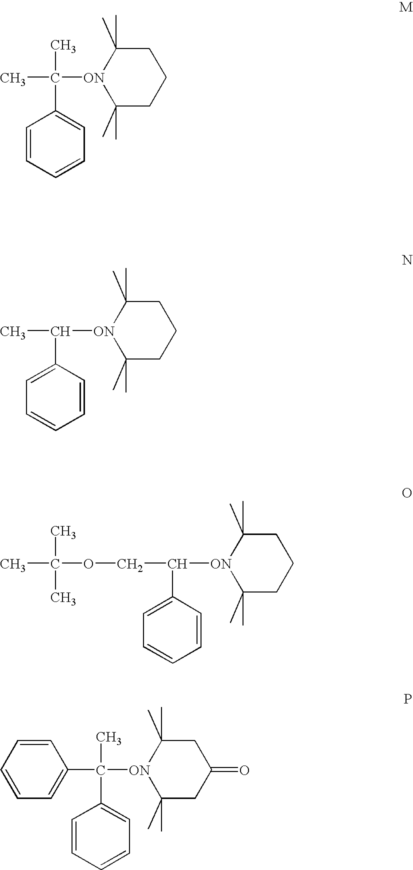

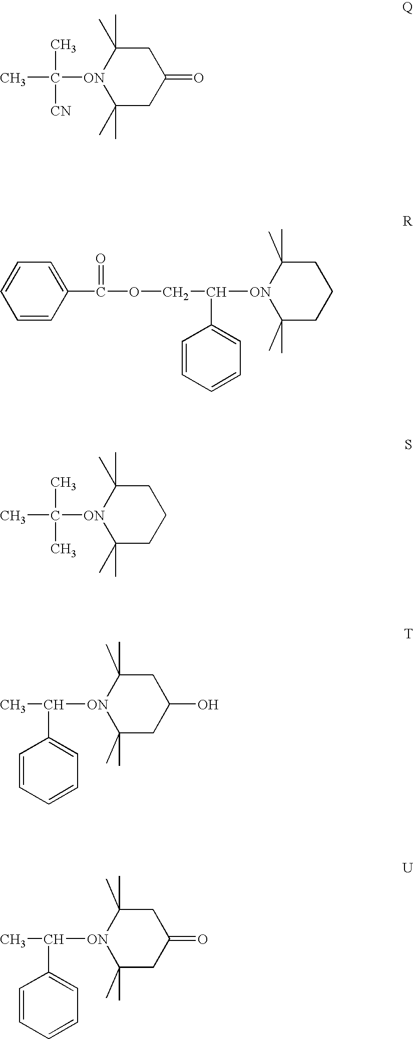

Compositions M through U are particularly suited for styrenic (co)polymerization processes.

In one embodiment of the present invention, the stable free radical is preferably present in the polymerization medium in an amount of 1 to 1,000 ppm based on the amount of (co)monomer. Preferably the stable free radical is present in an amount equal to or less than 1000 ppm, more preferably equal to or less than 750 ppm, more preferably equal to or less than 500 ppm, more preferably equal to or less than 250 ppm based on the amount of (co)monomer. Preferably the stable free radical is present in an amount equal to or greater than 1 ppm, more preferably equal to or greater than 5 ppm, more preferably equal to or greater than 10 ppm, more preferably equal to or greater than 25 ppm, more preferably equal to or greater than 50 ppm, more preferably equal to or greater than 75 ppm, and more preferably equal to or greater than 100 ppm based on the amount of (co)monomer.

In the process for producing a rubber-modified vinyl aromatic (co) polymer, within the ranges described hereinabove, when the stable free radical concentration is increased, the particle size of the rubber distribution tends to go from monomodal to bimodal and the volumetric fraction of the rubber phase in the final composition tends to increase. A given distribution is said to be bimodal when the curve representing the amount of particles as a function of their diameter presents two maximums. In the 1 to 1,000 ppm range, when one increases the concentration of stable free radicals, the impact resistance of the material generally passes to a maximum and the melt flow rate of the final composition tends to increase. This behavior is remarkable because, according to known art, these two properties, impact resistance and flowability, generally evolve in opposite directions. This characteristic makes the composition obtained, according to the invention, an ideal composition for injection molding of parts which require good impact resistance. To obtain a distribution that goes from monomodal to bimodal; a maximum impact resistance; the best balance of impact resistance and flowability for a specific application; or combinations thereof, the amount of stable free radical may depend on the nature and on the amount of the ingredients present in the polymerization as well as the polymerization conditions. For a given polymerization condition, a person skilled in the art may find out through routine tests at what stable free radical concentration the distribution becomes bimodal and for what stable free radical concentration, the impact resistance and flowability are optimal.

The process of the present invention may optionally comprise one or more radical polymerization initiator. The choice and the level of chemical initiator used will determine the polymerization temperatures. The initiator(s) may be added prior to the start of the polymerization process, immediately prior to the start of the polymerization process and/or it is possible to add the initiator(s) continuously or in portions, during the polymerization process. The one hour half life temperature (t_{1/2(x° C.)} or sometimes referred to as T_{1/2}(1 hr)) for a chemical initiator is defined herein as the temperature (x° C.) when 50 percent of the initiator will decompose into radicals within one hour. For example, the initiator is selected such that its half-life at the selected temperature for the method of the invention ranges from 30 seconds to 1 hour and preferably from 5 minutes to 30 minutes.

Preferably, for (vinyl aromatic) monomer (co)polymerization, one or more initiator is added in the feed mixture at the beginning of the process. If two or more polymerization initiators are used they may, or may not, have different half-lives. For example, two initiators with different half-life are used when one needs or desires a broader temperature window where free radicals are generated. The process for doing so is to have one initiator selected from a group of initiators with low half-life, and the other initiator selected from a group of high half-life initiators. Whether an initiator acts as a low half-life initiator or a high half-initiator may depend on the specific (co)monomer(s) being polymerized, stable free radical, and the like. For a given polymerization condition, a person skilled in the art may find out through routine tests if an initiator acts as a low half-life initiator or a high half-life initiator. Such initiators may be peroxide based, but also other types such as AZO initiators may be used and combinations of peroxide and AZO initiators may be used. However, if one defers from using free radical initiators and resides with pure thermal initiation through Diels Alder reactions of the vinyl (aromatic) monomer, these radicals may also be mediated with stable free radical chemistry.

The initiator for example can be selected from among diacyl peroxides, peroxy esters, dialkyl peroxides and peroxy acetals. The initiator, for example, can be selected from the following list: dibenzoyl peroxide, di-o-methylbenzoyl peroxide, di-3,5,5-trimethylhexanoyl peroxide, didecanoyl peroxide, dilauroyl peroxide, tert-butyl peroxybenzoate, tert-butyl peroxy-3,5,5-trimethylhexanoate, 2,5-dimethyl-2,5- is a di-(benzoyl peroxy)-hexane, tert-amyle peroxy-3,5,5-trimethylhexanoate, tert-butyl peroxy-2-ethyl-hexanoate, tert-amyl peroxy-2-ethyl-hexanoate, tert-butyl peroxypivalate, tert-amyl peroxypivalate, tert-butyl peroxy-neodecanoate, tert-amyl peroxy-neodecanoate, α-cumyl peroxy-neodecanoate, 3-hydroxy-1,1-dimethylbutyl peroxy-neodecanoate, 2,5-dimethyl-2,5-di(tert-butylperoxy)-hexane, 2,5-dimethyl-2,5-di(tert-butylperoxy)-hex-(3)-yne, tert-butyl peroxide and cumyl peroxide, dicumyl peroxide, di-tert-butyl peroxide, 1,1-di(tert-butylperoxy)-3,3,5-trimethylcyclohexane, 1,1-di(tert-butylperoxy)-cyclohexane, 2,2-di(tert-butylperoxy)-butane, n-butyl 4,4-di(tert-butylperoxy)-valerate, 3,3-di(tert-butylperoxy)-ethylbutyrate, and 3,3-di(tert-amylperoxy)-ethylbutyrate.

U.S. Pat. No. 6,770,716 to Sosa et al. discloses that accelerators can be used together with conventional peroxide initiators to accelerate the decomposition of the peroxides commonly used in the manufacture of vinyl aromatic polymers. The accelerator may be added prior to, during or after the initiator is added to the monomer. The result of this accelerated peroxide decomposition is an increase in polymerization rate and/or an increase in grafting of the rubber that is used. Suitable accelerators, sometimes referred to as decomposition catalysts, that increase the rate of decomposition of the peroxide initiator include, but are not necessarily limited to, hydroperoxides and/or metallic salts. Representative examples of suitable hydroperoxide accelerators include t-butyl hydroperoxide (TBH), cumyl hydroperoxide, and p-isopropyl cumyl hydroperoxide, whereas suitable metallic salt accelerators include cobalt naphthenate and cobalt acetoacetonate.

If a hydroperoxide accelerator, or decomposition catalyst, is used, it may be added in an amount from about 100 ppm to about 1200 ppm, preferably in an amount from about 200 ppm to about 600 ppm, ppm is based on the amount of monomer. If a metallic salt accelerator, or decomposition catalyst, is used, it may be added in an amount from about 10 ppm to about 1200 ppm, preferably an amount from about 50 ppm to about 600 ppm and more preferably from about 50 ppm to about 400 ppm, ppm is based on the amount of monomer.

A (co)polymer's molecular weight is directly related to the entanglement effects contributing to its rheological properties. The molecular weight of the (co)polymer produced in the present invention can be adjusted by the addition of a suitable chain transfer agent. Chain transfer agents, or molecular weight regulators, are substances which can undergo atom or group transfer or an addition-elimination. Organic molecules with labile hydrogens and are well known, for example, alpha-methyl styrene dimer, mercaptans or thiols such as n-dodecylmercaptan (nDM), mercaptan rubbers, and thioglycolate, disulfides, dithiauram disulfides, monosulfides, halides or halocarbons, common solvents and certain unsaturated compounds such as allyl peroxides, allyl halides, allyl sulfides, thioglycolates, terpenes such as terpinoline, unsaturated fats and oils and drying oils and their derivatives, for example fatty esters of linoleic and linolic acids, and vegetable oils such as linseed oil, especially those with two double bonds separated with only one methylene group (—CH₂—). Also transition metal complexes as cobalt(II) porphyrin complexes can be used as transfer agent.

Chain transfer agents are added in an amount from about 0.00001 to 10 weight percent based on the weight of the reaction mixture (that is, (co)monomers and rubber, and/or solvent, if any). Preferably, the chain transfer agent in the present invention is added in an amount equal to or greater than about 0.001 weight percent, preferably 0.002, and more preferably, 0.003 weight percent based on the weight of the reaction mixture. Preferably, the chain transfer agent in the present invention is added in an amount equal to or less than about 0.5 weight percent, preferably 0.4, and more preferably, 0.3 weight percent based on the weight of the reaction mixture.

The chain transfer agent may be added all at once in one reactor zone or preferably, it may be added in two or more reactor zones. In the case of making a rubber-modified (co)polymer, the chain transfer agent may be added before phase inversion/during rubber particle sizing, more may be added after particle sizing to help control the matrix molecular weight, and optionally more may be added later to fine tune the matrix molecular weight/molecular weight distribution. If the amount of chain transfer agent is added at the beginning of the polymerization in the present invention (in other words, at a time where the percent solids for the reaction mixture is equal to the weight percent rubber) it is added in a first amount equal to or greater than 0 weight percent, preferably between about 0.002 and about 0.02 weight percent, and more preferably between about 0.003 and about 0.01 weight percent based on the weight of the reaction mixture. The amount of chain transfer agent added later, for example between about 30 to about 40 percent solids, preferably 35 percent solids, is added in a second amount equal to or greater than about 0.03 weight percent, preferably between about 0.03 and about 0.1 weight percent, more preferably between about 0.03 and about 0.3 weight percent, and even more preferably, between about 0.1 and about 0.3 weight percent based on the weight of the reaction mixture. If more chain transfer agent is added, for example between about 40 to about 50 percent solids, preferably 45 percent solids, it is added in a third amount equal to or greater than about 0.03 weight percent, preferably between about 0.03 and about 0.05 weight percent, more preferably between about 0.03 and about 0.1 weight percent, and even more preferably, between about 0.05 and about 0.1 weight percent based on the weight of the reaction mixture. For example in the process of the present invention, chain transfer agent may be added in an amount from about 0 to 0.05 weight percent at the beginning of the polymerization, between about 0.03 to 0.3 weight percent at about 35 percent solids and between about 0.03 to 0.3 weight percent at 45 percent solids. Weight percent chain transfer agent is based on the weight of the total reaction mixture weight which is the weight of the (co)monomer(s) and rubber and/or solvent if employed.

The polymerization mixture may contain at least one organic solvent. The solvent is chosen so that it does not boil under polymerization conditions and so it is miscible with the vinyl aromatic monomer and the vinyl aromatic (co)polymer which derives therefrom. Suitable organic solvents are typically pure alkanes (hexane, heptant, octane, and isooctane), alicyclic hydrocarbons (cycloheane), hydrocarbons (benzene, ethylbenzene, toluene, and xylene), halogentated hydrocarbons (chlorobenzene), alkanols (methanol, ethanol, ethylene glycol, and ethylene glycol monomethyl ether), esters (ethyl acetate, propyl, butyl or hexyl acetate), and ethers (diethyl ether, dibutyl ether, and ethylene glycol dimethyl ether), or mixtures thereof.

The products of the claimed process are thermoplastic resin compositions. The thermoplastic resin compositions may also optionally contain one or more additives that are commonly used in compositions of this type. Preferred additives of this type include, but are not limited to: impact modifiers, fillers, reinforcements, ignition resistant additives, stabilizers, colorants, flow enhancers, antioxidants, antistats, etc. Preferred examples of additives are impact modifiers such as, but not limited to core-shell graft copolymers or fillers, such as, but not limited to talc, clay, wollastonite, mica, glass or a mixture thereof. Additionally, ignition resistance additives, such as, but not limited to halogenated hydrocarbons, halogenated carbonate oligomers, halogenated diglycidyl ethers, organophosphorous compounds such as monophosphates and/or oligomeric phosphates, fluorinated olefins such as polytetrafluoroethane (PTFE), antimony oxide, metal salts of aromatic sulfur, or mixtures thereof. Further, compounds which stabilize thermoplastic compositions against degradation due to causes such as, but not limited to heat, light, and oxygen, or a mixture thereof may be used. If used, such additives may be present in their typical effective amounts which may vary but range generally from about 0.01 part to about 25 parts by weight, preferably about 1 part to about 15 parts by weight, and more preferably from about 1 part to about 10 parts by weight based on 100 weight parts of the thermoplastic composition.

Also included within this invention are the reaction products, if any, of the above named components when admixed in the polymer blend compositions of this invention.

The thermoplastic resin compositions made by the process of this invention can be compounded, dry-blended, and/or melt-blended by any suitable mixing means known in the art, for example using a Henschel mixer, a ribbon blender, or a dough-mixer for dry blending and an extruder, mixing rolls, a Banbury mixer, or directly in an injection molding machine for melt-blending.

The thermoplastic resin compositions made by the process of this invention will softened or melt by the application of heat and they can be formed or molded into articles using conventional techniques such as compression molding, injection molding, gas assisted injection molding, calendaring, vacuum forming, thermoforming, extrusion and/or blow molding, alone or in combination. The thermoplastic resin compositions made by the process of the present invention can also be formed, spun, or drawn into films, fibers, multi-layer laminates or extruded sheets, or can be compounded with one or more organic or inorganic substances, on any machine suitable for such purpose.

The thermoplastic resin compositions produced by the process of the present invention can be fabricated, molded, or formed into a variety of articles, for example extruded articles such as sheet, profiles, and pipe; injection molded articles for transportation applications such as internal and external articles for automobile, truck, train, and bus applications, recreational vehicle applications such as articles for golf carts, boats, jet skis, snowmobiles, motorcycles, and yard tractors; housings or internal parts for consumer electronic applications such as computers, TVs, phones, cell phones, handheld or personal electronic devices, printers, copiers, scanners, video game consoles and accessories; multimedia applications; large appliances like refrigerator and freezer panels and parts, washing machine and dryer panels and parts; small appliance housings; tool housings; furniture articles, toys, and small to large storage containers.

To illustrate the practice of this invention, examples of preferred embodiments are set forth below. However, these examples do not in any manner restrict the scope of this invention.

### EXAMPLES

### Example 1 and Comparative Example A

The compositions of Example 1 and Comparative Example A are mass produced transparent impact modified polystyrene resins (TIPS) wherein two rubbers, styrene, and mineral oil are dissolved in ethylbenzene to form a reaction feed stream. One or more polymerization initiators are added to the reaction mixtures and in Example 1 a stable free radical is added. The mixtures are polymerized in a to continuous process while agitating said mixture. The polymerization occurs in a multi staged reactor system, sometimes referred to as a multiple reactor system, over an increasing temperature profile. During the polymerization process, some of the forming polymer grafts to the rubber molecules while some of it does not graft, but instead, forms the matrix homopolymer.

The continuous polymerization apparatus comprises three plug flow reactors connected in series. Each reactor is equipped with an agitator and is divided in three zones, for example, nine zones in all. Each zone has a separate temperature control and has one or more ports to allow the introduction of additives during different stages of the polymerization. The feed is continuously charged in zone 1 at such a rate that the total residence time in the apparatus is between 5-7 hours. A recycle feed may or may not be added. Samples can be taken at the end of each reactor. After passing through the reactors, the polymerization mixture is guided to a solvent/monomer recovery step using a preheater followed by a devolatilizer. The molten resin is stranded and cut in granular pellets.

The pellets are used to prepare physical property test specimens (other than gloss test specimens) on a Toyo 90 ton injection molding machine having the following molding conditions: Melt temperature of 260° C.; Mold temperature of 77° C.; Holding pressure of 9000 pounds per square inch (psi); Injection time of 1.63 seconds; Hold time of 30 seconds; Cooling time of 60 seconds; and Cycle time of 60 seconds.

The components of the reaction mixture and reactor conditions are given in Table 1 below, unless otherwise noted amounts are in weight percent. In Table 1 and Tables hereinafter:

“Rubber-1” is a high cis polybutadiene rubber with a solution viscosity of about 80 mPas;

“Rubber-2” is a low cis polybutadiene rubber with a solution viscosity between 150-190 mPas;

“Mineral oil” is available as Primol 382 from Esso;

“TRIGONOX 21” is t-butyl peroxy 2-ethyl hexanoate a polymerization initiator available from Akzo-Nobel;

“TRIGONOX 22” is 1,1-di(t-butyl peroxy)cyclohexane a polymerization initiator available from Akzo-Nobel;

“nDM” is n-dodecylmercaptan a chain transfer agent;

“O-TEMPO” is 4-oxo-2,2,6,6-tetramethyl-1-piperidinoxyl a stable free radical;

“TEMPO” is 2,2,6,6-tetramethyl-1-piperidinoxy a stable free radical;

“Recycle-1” is a mixture of 60 parts by weight styrene and 40 parts by weight ethylbenzene; and

“IRGANOX 1076 Mix” is a mixture of 2.4 weight percent IRGANOX™ 1076, 60 weight percent styrene, and 37.6 weight percent ethylbenzene. IRGANOX 1076 is 6-di-t-butyl-4-(octadecanoxycarbonylethyl)phenol an anti-oxidant available from Ciba Specialty Chemical.

TABLE 1

| | | COMPARATIVE |
|---|---|---|
| | EXAMPLE | EXAMPLE |
| | 1 | A |
| REACTION COMPONENTS | | |
| Styrene | 87.05 | 87.05 |
| Ethylbenzene | 2.91 | 2.91 |
| Rubber-1 | 5.71 | 5.71 |
| Rubber-2 | 1.43 | 1.43 |
| Mineral Oil | 2.9 | 2.9 |
| Trigonox 21 to zone 1, ppm | 177 | |
| Trigonox 22 to zone 1, ppm | 140 | 194 |
| O-TEMPO to zone 1, ppm | 72 | |
| nDM to zone 1, ppm | | 150 |
| Recycle-1 to zone 1, g/h | 56 | 56 |
| Recycle-1 to zone 4, g/h | 56 | 56 |
| IRGANOX 1076 Mix to zone 6, g/h | 18.3 | 18.3 |
| REACTOR CONDITIONS | | |
| Temperature, ° C. | | |
| Zone 1 | 110 | 109 |
| Zone 2 | 112 | 112 |
| Zone 3 | 114 | 116 |
| Zone 4 | 128 | 127 |
| Zone 5 | 138 | 138 |
| Zone 6 | 145 | 145 |
| Zone 7 | 167 | 167 |
| Zone 8 | 179 | 179 |
| Zone 9 | 182 | 182 |
| Agitation, rpm | | |
| Reactor 1 | 160 | 160 |
| Reactor 2 | 90 | 90 |
| Reactor 3 | 30 | 30 |
| Product rate, kg/h | 493 | 481 |

Product characterization and property test results from injection molded test specimens for Example 1 and Comparative Example A are reported in Table 2.

TABLE 2

| | | COMPARATIVE |
|---|---|---|
| | EXAMPLE | EXAMPLE |
| | 1 | A |
| PROCESS CHARATERIZATION | | |
| z′ | | |
| Zone 1 | 4085467 | |
| Zone 2 | 2828435 | |
| Zone 3 | 1747554 | |
| Zone 4 | 488451 | |
| Zone 5 | 146117 | |
| Zone 6 | 70059 | |
| Zone 7 | 8091 | |
| Zone 8 | 2722 | |
| Zone 9 | 2092 | |
| PRODUCT CHARACTERIZATION | | |
| Solids, weight percent | | |
| Reactor 1 | 30.4 | 30.2 |
| Reactor 2 | 60.2 | 60.8 |
| Reactor 3 | 83.8 | 81.8 |
| Mn, g/mole | | |
| Reactor 1 | 119,700 | 120,900 |
| Reactor 2 | 101,600 | 98,900 |
| Reactor 3 | 55,500 | 60,200 |
| Extruded Product | 55,200 | 60,500 |
| Mw, g/mole | | |
| Reactor 1 | 214,700 | 235,300 |
| Reactor 2 | 197,900 | 208,400 |
| Reactor 3 | 160,400 | 166,300 |
| Extruded Product | 163,900 | 159,500 |
| RPS, micrometer | | |
| Reactor 1 | 3.63 | 1.93 |
| Reactor 2 | 1.6 | 1.83 |
| Reactor 3 | | |
| Extruded Product | 1.36 | 2.00 |
| D_{z+1} RPS, micrometer | 0.81 | 2.47 |
| Extruded Product | | |
| Gloss, % | 62 | 22 |
| Haze, % | 71 | 74 |
| Cross-link Ratio | 0.595 | 0.508 |
| MFR-1 @ 200° C./5 kg, g/10 min | 9.9 | 10.2 |
| Izod, J/m | 165 | 148 |

In Table 2 and Tables hereinafter:

“Solids” is the ratio of the dried sample to the untreated sample (expressed as percentage) and is determined by flashing of the solvent and (co)monomer(s) in a vacuum oven. A two step process can be used. During the first step the sample is kept at 30° C. for 1 hour at full vacuum. During the second step the temperature of the sample is increased to 200° C. and is then kept at full vacuum for another 10 minutes;

“Mw” is the weight average molecular weight and “Mn” is the number average molecular weight. Both are determined by gel permeation chromatography (GPC) using narrow molecular weight polystyrene (PS) standards and tetrahydrofuran as solvent. An UV detector (254 nm) is used. Results are reported as kilogram per mole (kg/mole);

“RPS” is the volumetric mean rubber particle size determined using a Coulter Multisizer Ile (electrosensing technique) using the ACCUCOMP™ Software Version 2.01. About 3 granules of polymer samples (30-70 mg) are dissolved in 5 ml of DMF, using sonication for approximately 15 to 20 minutes. 10 ml of an electrolyte solution (1 percent NH₄SCN in DMF) is mixed with 0.2 ml of the sample solution. The appropriate Coulter tube (for example 30 μm aperture) has to be used in combination with a calibration material. The coincidence level indicator of the apparatus should read between 5 and 10 percent. If the reading is above 10 percent, dilute the sample solution with electrolyte solution, or, if it is too low, add more drops of the polymer solution in DMF. The particle size is reported in micrometer (μm).

“D_{z+1} RPS” is the average rubber particle diameter determined from transmission electron micrograph (TEM) samples prepared from melt flow rate strands produced by means of an extrusion plastometer at 220° C. and 3.8 kg load. A sample is cut from a strand to fit in a microtome chuck. The area for microtomy is trimmed to approximately 1 square millimeter (mm²) and stained in OsO₄ vapor overnight at 24° C. Ultrathin sections are prepared using standard microtomy techniques. 70 Nanometer thin sections are collected on Cu grids and are studied in a Philips CM12 Transmission Electron microscope at 120 KV. The resulting micrographs are analyzed for rubber particle size distribution by means of a Leica Quantimet Q600 image analyzer. Images are scanned with a resolution of 0.005 micrometer/pixel in auto contrast mode in which the white level is adjusted first to give full-scale output on the whitest part of the image then black level is adjusted to give zero output on the darkest part of the image. Unwanted artifacts in the background are removed by a smooth white morphological transform.

Micrographs show particles which are not cut through the middle. A correction method developed by Scheil (E. Scheil, Z. Anorg. Allgem. Chem. 201, 259 (1931); E. Scheil, Z. Mellkunde 27 (9), 199 (1935); E. Scheil, Z. Mellkunde 28(11), 240 (1936)) and Schwartz (H. A. Schwartz, Metals and Alloys 5 (6), 139 (1934)) is slightly modified to take the section thickness (t) into account. The measured area of each rubber particle (aᵢ) is used to calculate the equivalent circle diameter nᵢ: this is the diameter of a circle having the same area as the rubber particle. The distribution of nᵢ is divided into m discrete size classes across the observed range of particle sizes.

$${N}_{i} = \frac{{n}_{i} + {\sum }_{j = i + 1}^{m} {N}_{j} \sqrt{{d}_{j}^{2} - {d}_{i}^{2}} - \sqrt{{d}_{j}^{2} - {d}_{i - 1}^{2}}}{t + \sqrt{{d}_{i}^{2} - {d}_{i - 1}^{2}}}$$

Nᵢ: number of particles in class i after correction
dᵢ: maximum diameter of class i
m: total number of classes.
nᵢ: number of particles in class i before correction

Once Nᵢ versus dᵢ is obtained, the volume average diameter (Dᵥ) and the z+1 average diameter (D_{z+1}) of the rubber particles is calculated as follows:

$${D}_{v} = \sqrt[3]{\frac{{\sum }_{i = 1}^{m} {N}_{i} \cdot {d}_{i}^{3}}{N}}$$

$${D}_{z + 1} = \frac{{\sum }_{i = 1}^{m} {N}_{i} \cdot {d}_{i}^{4}}{{\sum }_{i = 1}^{m} {N}_{i} \cdot {d}_{i}^{3}} ;$$

“Gloss” is determined by 60° Gardner gloss on specimens prepared from molded samples, 30 minutes after molding, according to ISO 2813 with “Dr. Lange RB3” reflectometer. Gloss specimens are molded on an Arburg 170 CMD Allrounder injection molding machine, having the following molding conditions: Barrel temperature settings of 210, 215, and 220° C.; Nozzle temperature of 225° C., Mold temperature of 30° C.; Injection pressure: 1500 bar; Holding pressure 50 bar; Holding time 6 seconds; Cavity switch pressure: 200 bar; Cooling time: 30 seconds; and Injection speed: 10 cubic centimeters per second (cm³/s). The dimensions of the molded plaque are 64.2 mm×30.3 mm×2.6 mm. Intrinsic gloss is measured in the center of the plaque on the surface at which the pressure is measured. The materials are injected through one injected point located in the middle of the short side of the mold. During injection molding, the injection pressure switches to holding pressure when the cavity pressure reaches the pre-set value. The pressure transducer is located at a distance of 19.2 mm from the injection point. By using a constant pre-set cavity pressure value, the weight of the molded plaques is the same for materials with different flow characteristics. The polishing of the mold is according to SPI-SPE1 standard of the Society of Plastic Engineers;

Haze is determined on injection molded plaques using a Demag Ergotech ET800/420-310 equipped with a 35 or 25 mm diameter mixing screw.

Molding conditions:
Mold temperature set point: 50° C.
Holding time: 5-10 s
Holding pressure profile: 850-500 bar
Melt temperature: 235° C.
   A plaque mold with both sides highly polished (N0) is used to prepare plaques measuring 60×60×0.4 mm. The haze measurement is done according to ASTM D1003-95 using a Hunterlab CQ-SPERE/SN 5521. A Mitutoyo “Absolute” Digimatic Thickness gauge, series 547-315 type D, measuring range 0-10 mm, graduation 0.01 is used for thickness measurements. Haze is determined according to ASTM D1003-00. The value “x” is the thickness of the plaque where the haze is determined. The turbidity (τ) is calculated as follows:

$$τ = - \frac{1}{x} ln ( 1 - \frac{haze}{100} )$$

This turbidity is used to calculate the haze for the standard thickness of 500 μm:

% haze=100*(1−(exp(−τ*500))

“Cross-link ratio” is determined by a light absorbance test. The cross-link ratio is the ratio of light absorbance (LAR) for a suspension of the rubber particles in dimethyl formamide (DMF) the light absorbance for a suspension of the rubber particles in dichloromethane (DCM). LAR can be determined using a Brinkmann model PC 800 probe colorimeter equipped with a 450 nm wavelength filter, from Brinkmann Instruments Inc:, Westbury, New York, or equivalent. In a first vial, a 0.4 gram (g) sample of rubber-modified copolymer is dissolved in 40 milliliters (ml) DMF. From the first vial, 5 ml of the resulting DMF solution is added to a second vial containing 40 ml of DMF. From the first vial, 5 ml of the resulting DMF solution is added to a third vial containing 20 ml DCM. The probe is zeroed in neat DMF. The absorption of the DMF solution in the second vial and the absorption of the DCM solution in the third vial are determined. The light absorbance ratio is calculated by the following equation:

$$L A R = \frac{Absorbance in D M F}{Absorbance in D C M} ;$$

“MFR-1” is melt flow rate determined according to ASTM D1238 on a Zwick 4105 01/03 plastometer at 200° C. and an applied load of 5 kg, samples are conditioned at 80° C. for 2 hours before testing and results are reported as gram per 10 minutes (g/10 min);

“Izod” is notched Izod impact resistance determined according to ASTM D256 at 23° C. results are reported as Joules per meter (J/m); and

“z′” the mediation constant is determined from the required rate constants for the styrene-TEMPO system which have been determined by Minaux E, see Controlled Radical Polymerization at Pressures Up to 2000 Bar Dissertation zur Erlangen des Doktorgrades der Mathermatisch-Naturwissenschaftlichen Fakultaten der Georg August Universitat zu Gottingen (2001). At low pressures the contribution of the pressure is negligible and the expressions for the rate constant can be reduced to standard Arrhenius equations

kₚ=3.47·10⁷exp((−4100/T)+0.126P/T)L·mol⁻¹s⁻¹

kₐ=2.00·10¹³exp((−14940/T)−0.145P/T)s⁻¹

k_{c}=7.11·10⁶exp((−824/T)−0.265P/T)L·mol⁻¹s⁻¹

wherein T (K) and P (bar). FIG. 1 shows z′ calculated for a styrene-TEMOP system at a constant pressure (P) of 4 bar as function of temperature (T).

Hereinafter, this styrene-TEMPO (TEMPO/ST) system is used as a reference to determine rate constants for different polymerization systems, for example, those comprising one or more comonomers. Different systems can be related to TEMPO/ST using the following differential scanning calorimetry (DSC) procedure to estimate the shift in z′:

DSC experiments are performed via a TA Instruments model 2010 DSC running on a model 4400 controller. Data are collected and reduced using version 3.1 of the Universal Analysis software package. A sample weighing approximately 1 mg is accurately weighed using a Mettler analytical balance. The sample is placed in a capillary, cooled with liquid nitrogen and purged with nitrogen before sealing.

DSC Program:
1: Equilibrate at 100.00° C.
2: Ramp 2.00° C./min to 220.00° C.
   The mixtures (parts by weight) used to determine the correction factor are summarized in Table 3:

TABLE 3

| | O- | | | | N- | | n- | |
|---|---|---|---|---|---|---|---|---|
| TEMPO | TEMPO | MI | ST | AN | PMI | αMeST | BA | EB |
| 0.01 | | | 95.00 | | | | | 4.99 |
| | 0.0109 | | 95.00 | | | | | 4.99 |
| | 0.0109 | | 71.25 | 23.75 | | | | 4.99 |
| | 0.0109 | | 66.50 | 28.50 | | | | 4.99 |
| | 0.0109 | | 67.69 | 22.56 | 4.75 | | | 4.99 |
| | 0.0109 | | 64.13 | 21.37 | 9.50 | | | 4.99 |
| | 0.0109 | | 67.69 | 22.56 | | 4.75 | | 4.99 |
| | 0.0109 | | 64.13 | 21.37 | | 9.50 | | 4.99 |
| | 0.0109 | | 67.69 | 22.56 | | | 4.75 | 4.99 |
| | 0.0109 | | 64.13 | 21.37 | | | 9.50 | 4.99 |
| | | 0.0378 | 95.00 | | | | | 4.99 |

ST: styrene
AN: acrylonitrile
N-PMI: N-phenyl maleimide
αMeST: α-methyl styrene
nBA: n-butyl acrylate
MI: microinitiator (described hereinafter in Examples 25 to 34)

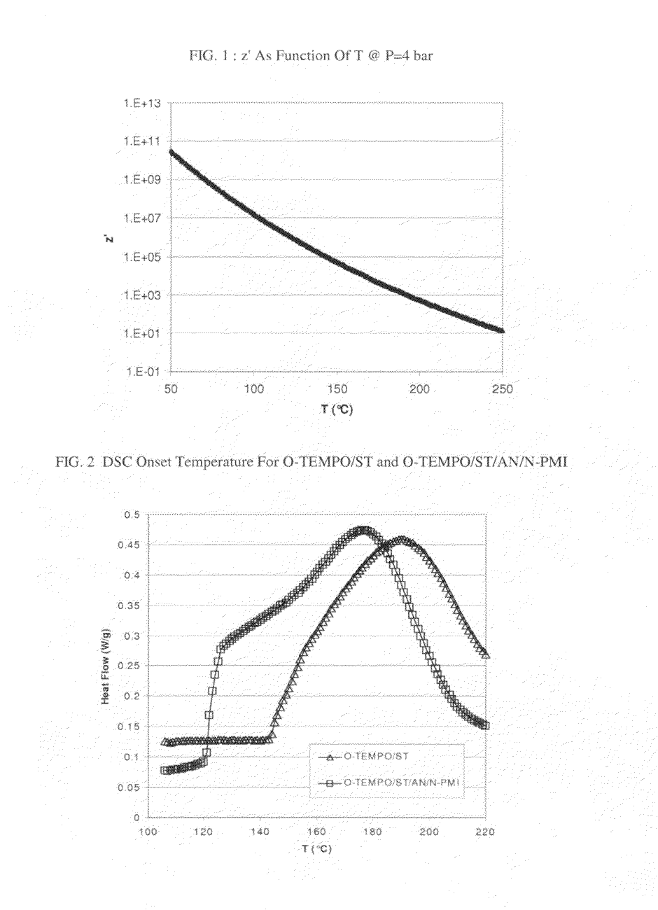

100 ppm TEMPO is used to run the experiments. When a stable free radical other than TEMPO is used, such as O-TEMPO, a molar equivalent is used. For example, the molar equivalent of 100 ppm TEMPO is 109 ppm O-TEMPO (M_{TEMPO}=156 versus M_{oxo-TEMPO}=170). It is adviced to use the c factor in the monomer concentration range used for the experiments. FIG. 2 is a DSC plot showing the onset temperatures for an O-TEMPO/ST mixture and an O-TEMPO/ST/AN/N-PMI mixture.

Replacing the rate constants by an overall Arrhenius equation in Equation 13 gives Equation 27 (neglecting pressure dependence):

z′=Aexp(−B/T) (24)

wherein A is the pre-exponential factor and B is the activation energy.
To address the change in reactivity when another polymerization system is in place, z′ will be calculated using a mathematical transformation similar to the Arrhenius equation using c as correction factor:

z′=Pexp(−Q/(T+c)) (25)

The correction factor is determined using DSC where the new system is compared to the standard system, styrene-TEMPO. A thermal initiated run is done and the start of the polymerization is used to determine the c factor. The onset temperature is determined by a change in slope of the exotherm. The c factor is determined as the onset temperature for the reference minus the onset temperature for the new system (see FIG. 2)

c=T_{reference}−T_{new system} (26)

Table 4 shows different systems and summarizes the onset temperature and the calculated correction factor.

TABLE 4

| Stable Free | Monomer | Monomer | | Onset T, | c factor, |
|---|---|---|---|---|---|
| Radical | 1 | 2 | Monomer 3 | ° C. | ° C. |
| TEMPO | ST | | | 145 | |
| O-TEMPO | ST | | | 143 | 2 |
| O-TEMPO | ST | AN | | 137 | 8 |
| O-TEMPO | ST | AN | N-PMI | 121 | 24 |
| O-TEMPO | ST | AN | αMeST | 133 | 12 |
| O-TEMPO | ST | AN | n-BA | 139 | 6 |
| MI | ST | | | 126 | 19 |

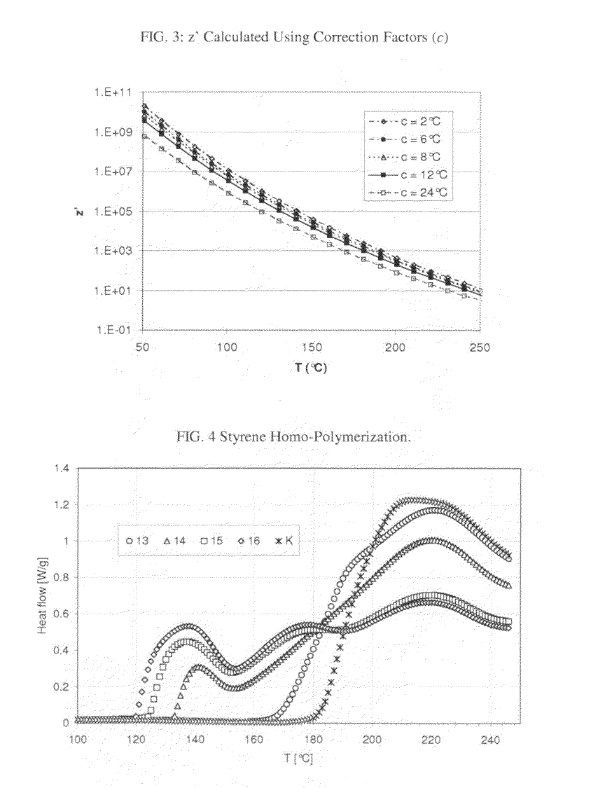

From the individual correction factors, z′ can be determined for different systems as a function of temperature (FIG. 3).

### Examples 2 to 10 and Comparative Examples B to H

The compositions of Examples 2 to 10 and Comparative Examples B to H are mass produced acrylonitrile, butadiene, and styrene terpolymer (ABS) resins wherein two rubbers, acrylonitrile, and styrene are dissolved in ethylbenzene to form a reaction feed stream. One or more polymerization initiators are added to the reaction mixtures and in Examples 2 to 10 a stable free radical is added. The mixtures are polymerized in a continuous process while agitating said mixture. The polymerization occurs in a multi staged reactor system over an increasing temperature profile. During the polymerization process, some of the forming polymer grafts to the rubber molecules while some of it does not graft, but instead, forms the matrix copolymer.

The continuous polymerization apparatus comprises four plug flow reactors connected in series. Each reactor is equipped with an agitator and is divided in three zones, for example, 12 zones in all. Each zone has a separate temperature control and has one or more ports to allow the introduction of additives during different stages of the polymerization. The feed is continuously charged in zone 1 at such a rate that the total residence time in the apparatus is between 4 to 5 hours. One or more recycle feed may or may not be added. Samples can be taken at the end of each reactor. After passing through the reactors, the polymerization mixture is guided to a solvent/monomer recovery step using a preheater followed by one or more devolatilizer (Devo). The molten resin is stranded and cut in granular pellets.

The pellets are used to prepare physical property test specimens (other than gloss test specimens, which are prepared as described hereinabove) on a Toyo 90 ton injection molding machine operating at a Holding pressure of 9000 psi; Injection time of 1.63 seconds (s); Hold time of 12 s; Cooling time of 25 s; and Cycle time of 44 s. The Melt temperature is 250° C. and the Mold temperature is 60° C.

The components of the reaction mixture and reactor conditions are given in Table 5 below, unless otherwise noted amounts are in weight percent. In Table 5 and Tables hereinafter:

“Rubber-3” is a low cis star branched polybutadiene rubber with a solution viscosity of about 44 mPas;

“Rubber-4” is a low cis linear styrene/butadiene block rubber having 30% styrene with a solution viscosity of 25 mPas available as SOLPRENE™ 1322 from Housmex;

“Recycle-2” is a mixture of 38.5 parts by weight ethyl benzene, 57.3 parts by weight styrene, and 4.2 parts by weight acrylonitrile; and

“Δ Hydraulic Pressure” is the agitator hydraulic differential pressure which is the agitator motor inlet hydraulic pressure minus the outlet pressure. This is a direct measurement of how much force is needed to turn the agitator at a given speed and condition. The larger the differential, the more difficult it is to move the agitator due to higher torque. Δ Hydraulic Pressure is reported in pounds per square inch (psi).

TABLE 5

| | COMPARATIVE EXAMPLE | | | | | | | EXAMPLE | |
|---|---|---|---|---|---|---|---|---|---|
| | B | C | D | E | F | G | H | 2 | 3 |
| REACTION COMPONENTS | | | | | | | | | |
| Styrene | 57 | 57 | 57 | 57 | 57 | 57 | 57 | 57 | 57 |
| Acrylonitrile | 16 | 16 | 16 | 16 | 16 | 16 | 16 | 16 | 16 |
| Ethylbenzene | 15 | 15 | 15 | 15 | 15 | 15 | 15 | 15 | 15 |
| Rubber-3 | 3.5 | 3.5 | 3.5 | 3.5 | 3.5 | 3.5 | 3.5 | 3.5 | 3.5 |
| Rubber-4 | 8.5 | 8.5 | 8.5 | 8.5 | 8.5 | 8.5 | 8.5 | 8.5 | 8.5 |
| Trigonox 21 to zone 1, ppm | | | | | | | | 70 | 70 |
| Trigonox 22 to zone 1, ppm | 113 | 116 | 16 | 117 | 117 | 117 | 117 | 100 | 100 |
| O-TEMPO to zone 1, ppm | | | | | | | | 70 | 70 |
| nDM to zone 1, ppm | 170 | 174 | 50 | | | | | | |
| nDM to zone 5, ppm | | | 1000 | 1500 | 2000 | 2500 | 2000 | 300 | 300 |
| nDM to zone 7, ppm | 1332 | 1364 | 1367 | 1369 | 1369 | 1369 | 700 | 2000 | 2400 |
| Recyelc-2 to zone 4, g/h | 358 | 358 | 358 | 358 | 358 | 358 | 358 | 358 | 358 |
| Recycle-2 to zone 7, g/h | 500 | 500 | 500 | 500 | 500 | 500 | 500 | 500 | 500 |
| Recycle-2 to zone10, g/h | 327 | 327 | 327 | 327 | 327 | 327 | 327 | 327 | 327 |
| IRGANOX 1076 Mix to zone 8, g/h | 192 | 192 | 192 | 192 | 192 | 192 | 192 | 192 | 192 |
| REACTOR CONDITIONS | | | | | | | | | |
| Feed Rate, kg/h | 18.16 | 18.16 | 18.16 | 18.16 | 18.16 | 18.16 | 18.16 | 18.16 | 18.16 |
| Temperature, ° C. | | | | | | | | | |
| Zone 1 | 108 | 108 | 108 | 108 | 108 | 108 | 108 | 108 | 108 |
| Zone 2 | 110 | 110 | 110 | 110 | 110 | 110 | 110 | 110 | 110 |
| Zone 3 | 114 | 114 | 114 | 114 | 114 | 114 | 114 | 114 | 114 |
| Zone 4 | 117 | 117 | 117 | 117 | 117 | 117 | 117 | 117 | 117 |
| Zone 5 | 119 | 119 | 119 | 119 | 119 | 119 | 119 | 119 | 119 |
| Zone 6 | 121 | 121 | 121 | 121 | 121 | 121 | 121 | 121 | 121 |
| Zone 7 | 124 | 124 | 124 | 124 | 124 | 124 | 124 | 124 | 124 |
| Zone 8 | 131 | 131 | 131 | 131 | 131 | 131 | 131 | 131 | 131 |
| Zone 9 | 141 | 141 | 141 | 141 | 141 | 141 | 141 | 141 | 141 |
| Zone 10 | 152 | 152 | 152 | 152 | 152 | 152 | 152 | 152 | 152 |
| Zone 11 | 162 | 162 | 162 | 162 | 162 | 162 | 162 | 162 | 162 |
| Zone 12 | 173 | 173 | 173 | 173 | 173 | 173 | 173 | 173 | 173 |
| Agitation, rpm | | | | | | | | | |
| Reactor 1 | 100 | 100 | 100 | 100 | 100 | 100 | 100 | 100 | 100 |
| Reactor 2 | 100 | 100 | 100 | 100 | 100 | 100 | 100 | 100 | 100 |
| Reactor 3 | 50 | 50 | 50 | 50 | 50 | 50 | 50 | 50 | 50 |
| Reactor 4 | 10 | 10 | 10 | 10 | 10 | 10 | 10 | 10 | 10 |
| Δ Hydraulic Pressure, psi | | | | | | | | | |
| Reactor 1 | 170 | 166 | 172 | 172 | 173 | 171 | 174 | 170 | 169 |
| Reactor 2 | 217 | 211 | 234 | 232 | 236 | 234 | 234 | 217 | 218 |
| Reactor 3 | 130 | 127 | 117 | 116 | 117 | 113 | 119 | 118 | 115 |
| Reactor 4 | 66 | 63 | 53 | 54 | 53 | 50 | 54 | 59 | 56 |
| Devo 1, ° C. | 200 | 200 | 200 | 200 | 200 | 200 | 200 | 200 | 200 |
| Devo 2, ° C. | 245 | 245 | 245 | 245 | 245 | 245 | 245 | 245 | 245 |

| | EXAMPLE | | | | | | |
|---|---|---|---|---|---|---|---|
| | 4 | 5 | 6 | 7 | 8 | 9 | 10 |
| REACTION COMPONENTS | | | | | | | |
| Styrene | 57 | 57 | 57 | 57 | 57 | 57 | 57 |
| Acrylonitrile | 16 | 16 | 16 | 16 | 16 | 16 | 16 |
| Ethylbenzene | 15 | 15 | 15 | 15 | 15 | 15 | 15 |
| Rubber-3 | 3.5 | 3.5 | 3.5 | 3.5 | 3.5 | 3.5 | 3.5 |
| Rubber-4 | 8.5 | 8.5 | 8.5 | 8.5 | 8.5 | 8.5 | 8.5 |
| Trigonox 21 to zone 1, ppm | 70 | 70 | 70 | 70 | 70 | 70 | 70 |
| Trigonox 22 to zone 1, ppm | 100 | 100 | 100 | 100 | 100 | 100 | 100 |
| O-TEMPO to zone 1, ppm | 70 | 70 | 70 | 70 | 70 | 50 | 50 |
| nDM to zone 1, ppm | | | | | | | |
| nDM to zone 5, ppm | 300 | 301 | 301 | 301 | 301 | 599 | 500 |
| nDM to zone 7, ppm | 1364 | 1366 | 1366 | 2000 | 2400 | 2401 | 2401 |
| Recyelc-2 to zone 4, g/h | 358 | 358 | 358 | 358 | 358 | 358 | 358 |
| Recycle-2 to zone 7, g/h | 500 | 500 | 500 | 500 | 500 | 500 | 500 |
| Recycle-2 to zone10, g/h | 327 | 327 | 327 | 327 | 327 | 327 | 327 |
| IRGANOX 1076 Mix to zone 8, g/h | 192 | 192 | 192 | 192 | 192 | 192 | 192 |
| REACTOR CONDITIONS | | | | | | | |
| Feed Rate, kg/h | 18.16 | 18.16 | 18.16 | 18.16 | 18.16 | 18.16 | 18.16 |
| Temperature, ° C. | | | | | | | |
| Zone 1 | 108 | 108 | 108 | 108 | 108 | 108 | 108 |
| Zone 2 | 110 | 110 | 110 | 110 | 110 | 110 | 110 |
| Zone 3 | 114 | 114 | 114 | 114 | 114 | 114 | 114 |
| Zone 4 | 117 | 117 | 117 | 117 | 117 | 117 | 117 |
| Zone 5 | 119 | 119 | 119 | 119 | 119 | 119 | 119 |
| Zone 6 | 121 | 121 | 121 | 121 | 121 | 121 | 121 |
| Zone 7 | 124 | 124 | 124 | 124 | 124 | 124 | 124 |
| Zone 8 | 131 | 131 | 131 | 131 | 131 | 131 | 131 |
| Zone 9 | 141 | 141 | 141 | 141 | 141 | 141 | 141 |
| Zone 10 | 152 | 152 | 152 | 152 | 152 | 152 | 152 |
| Zone 11 | 162 | 162 | 162 | 162 | 162 | 162 | 162 |
| Zone 12 | 173 | 173 | 173 | 173 | 173 | 173 | 173 |
| Agitation, rpm | | | | | | | |
| Reactor 1 | 100 | 100 | 100 | 100 | 100 | 100 | 100 |
| Reactor 2 | 100 | 100 | 100 | 100 | 100 | 100 | 100 |
| Reactor 3 | 50 | 50 | 50 | 50 | 50 | 50 | 50 |
| Reactor 4 | 10 | 10 | 10 | 10 | 10 | 10 | 10 |
| Δ Hydraulic Pressure, psi | | | | | | | |
| Reactor 1 | 168 | 164 | 163 | 166 | 161 | 169 | 169 |
| Reactor 2 | 214 | 227 | 220 | 221 | 225 | 228 | 235 |
| Reactor 3 | 118 | 127 | 123 | 118 | 114 | 109 | 116 |
| Reactor 4 | 63 | 62 | 60 | 56 | 53 | 49 | 52 |
| Devo 1, ° C. | 200 | 200 | 200 | 200 | 200 | 200 | 200 |
| Devo 2, ° C. | 245 | 245 | 245 | 245 | 245 | 245 | 245 |

Product characterization and property test results on injection molded samples are reported in Table 6. In Table 6 and Tables hereinafter:

“Charpy” is notched (V-notch) Charpy impact resistance determined according to the ISO 179 1eA at 23° C. and

“LS-230 RPS” is the mean volume average rubber particle size as determined by the Beckman Coulter Particle Characterization LS-230 instrument light scattering method using LS230 Beckman Particle Characterization software, version 3.01: wherein 6-8 granules of polymer sample is dissolved in approximately 10 ml DMF using sonication for a minimum of 15 minutes. The following optical model parameter values are used: Fluid refractive index (ηfluid)=1.431, Sample “real” refractive index (ηsample/real)=1.570, and Sample “imaginary” refractive index (ηsample/imaginary)=0.01. Drops of dissolved sample are added until sample obscuration is in the 45.0 to 55.0% range. The mean volume average particle size is reported in micrometer (μm).

### Examples 11 to 12 and Comparative Examples I to J

The compositions of Examples 11 to 12 and Comparative Examples I to J are mass produced ABS resins wherein a rubber, acrylonitrile, styrene, and optionally n-phenyl maleimide (N-MPI) are dissolved in ethylbenzene and polymerized in a batch reactor equipped with an Auger type of agitator. The feed is charged into the nitrogen flushed reactor. Other reaction mixture components (initiator, chain transfer, etc.) can be added at any time through a separate port. The temperature is increased according to a predefined temperature profile. The agitator speed can be changed during the process. Samples can be taken throughout run. When the desired degree of polymerization is achieved the reactor is drained giving a prepolymer. The prepolymer is put in a vacuum oven to remove the solvent and any unreacted monomer(s).

TABLE 6

| | COMPARATIVE EXAMPLE | | | | | | | EXAMPLE | |
|---|---|---|---|---|---|---|---|---|---|
| | B | C | D | E | F | G | H | 2 | 3 |
| PROCESS CHARACTERIZATION | | | | | | | | | |
| z′ | | | | | | | | | |
| Zone 1 | | | | | | | | 2220500 | 2220500 |
| Zone 2 | | | | | | | | 1747554 | 1747554 |
| Zone 3 | | | | | | | | 1090311 | 1090311 |
| Zone 4 | | | | | | | | 770181 | 770181 |
| Zone 5 | | | | | | | | 612650 | 612650 |
| Zone 6 | | | | | | | | 488451 | 488451 |
| Zone 7 | | | | | | | | 349185 | 349185 |
| Zone 8 | | | | | | | | 162627 | 162627 |
| Zone 9 | | | | | | | | 57043 | 57043 |
| Zone 10 | | | | | | | | 19054 | 19054 |
| Zone 11 | | | | | | | | 7372 | 7372 |
| Zone 12 | | | | | | | | 2722 | 2722 |
| PRODUCT CHARACTERIZATION | | | | | | | | | |
| Product Rate, kg/h | 13.4 | 13.2 | 13.2 | 12.9 | 13.0 | 13.0 | 13.2 | 13.7 | 13.7 |
| Solids, weight percent | | | | | | | | | |
| Reactor 1 | 21.8 | 21.7 | 24.1 | 23.5 | 23.7 | 23.4 | 23.9 | 22.9 | 22.0 |
| Reactor 2 | 42.4 | 43.2 | 41.9 | 40.8 | 40.9 | 41.8 | 41.8 | 39.8 | 39.9 |
| Reactor 3 | 50.1 | 54.4 | 53.0 | 52.4 | 54.9 | 55.8 | 54.9 | 53.9 | 53.9 |
| Mn, g/mole | | | | | | | | | |
| Reactor 1 | 138500 | 138700 | 175400 | 200800 | 193100 | 199900 | 207700 | 138100 | 137100 |
| Reactor 2 | 147600 | 147200 | 89100 | 76600 | 68700 | 54500 | 62900 | 124400 | 136500 |
| Extruded Product | 58400 | 60100 | 43800 | 42100 | 37300 | 32900 | 41600 | 43300 | 38300 |
| Mw, g/mole | | | | | | | | | |
| Reactor 1 | 255800 | 246900 | 325100 | 368800 | 365900 | 368300 | 371800 | 250200 | 247500 |
| Reactor 2 | 278600 | 274200 | 230800 | 243200 | 243800 | 231900 | 237000 | 241200 | 243700 |
| Extruded Product | 169300 | 170700 | 142100 | 145300 | 140800 | 136100 | 145000 | 135900 | 131900 |
| LS-230 RPS, micrometer | | | | | | | | | |
| Extruded Product, mean | 0.47 | 0.47 | 0.50 | 0.42 | 0.44 | 0.47 | 0.44 | 0.41 | 0.41 |
| Gloss | 56 | 60 | 49 | 58 | 64 | 63 | 55 | 68 | 71 |
| Charpy, kJ/m² | 30 | 26 | 20 | 15 | 12 | 11 | 17 | 22 | 19 |
| MFR-1, g/10 min | 11 | 11 | 24 | 31 | 39 | 46 | 28 | 19 | 21 |

| | EXAMPLE | | | | | | |
|---|---|---|---|---|---|---|---|
| | 4 | 5 | 6 | 7 | 8 | 9 | 10 |
| PROCESS CHARACTERIZATION | | | | | | | |
| z′ | | | | | | | |
| Zone 1 | 2220500 | 2220500 | 2220500 | 2220500 | 2220500 | 2220500 | 2220500 |
| Zone 2 | 1747554 | 1747554 | 1747554 | 1747554 | 1747554 | 1747554 | 1747554 |
| Zone 3 | 1090311 | 1090311 | 1090311 | 1090311 | 1090311 | 1090311 | 1090311 |
| Zone 4 | 770181 | 770181 | 770181 | 770181 | 770181 | 770181 | 770181 |
| Zone 5 | 612650 | 612650 | 612650 | 612650 | 612650 | 612650 | 612650 |
| Zone 6 | 488451 | 488451 | 488451 | 488451 | 488451 | 488451 | 488451 |
| Zone 7 | 349185 | 349185 | 349185 | 349185 | 349185 | 349185 | 349185 |
| Zone 8 | 162627 | 162627 | 162627 | 162627 | 162627 | 162627 | 162627 |
| Zone 9 | 57043 | 57043 | 57043 | 57043 | 57043 | 57043 | 57043 |
| Zone 10 | 19054 | 19054 | 19054 | 19054 | 19054 | 19054 | 19054 |
| Zone 11 | 7372 | 7372 | 7372 | 7372 | 7372 | 7372 | 7372 |
| Zone 12 | 2722 | 2722 | 2722 | 2722 | 2722 | 2722 | 2722 |
| PRODUCT CHARACTERIZATION | | | | | | | |
| Product Rate, kg/h | 13.5 | 13.5 | 13.2 | 13.2 | 13.3 | 13.2 | 13.4 |
| Solids, weight percent | | | | | | | |
| Reactor 1 | 23.2 | 22.7 | 22.8 | 22.8 | 22.1 | 22.9 | 23.1 |
| Reactor 2 | 40.6 | 41.2 | 41.6 | 43.6 | 40.9 | 41.6 | 42.6 |
| Reactor 3 | 53.5 | 54.4 | 55.6 | 52.7 | 52.5 | 49.7 | 53.9 |
| Mn, g/mole | | | | | | | |
| Reactor 1 | 140500 | 147400 | 141500 | 140700 | 136600 | 152000 | 147600 |
| Reactor 2 | 119100 | 128200 | 101600 | 124000 | 123900 | 97300 | 105700 |
| Extruded Product | 50300 | 49800 | 51200 | 43700 | 38000 | 36500 | 38100 |
| Mw, g/mole | | | | | | | |
| Reactor 1 | 252400 | 262200 | 253900 | 257200 | 251600 | 279000 | 274900 |
| Reactor 2 | 238100 | 255400 | 235200 | 243900 | 243300 | 226500 | 251900 |
| Extruded Product | 142700 | 149000 | 142700 | 138400 | 130800 | 128100 | 135700 |
| LS-230 RPS, micrometer | | | | | | | |
| Extruded Product, mean | 0.41 | 0.43 | 0.41 | 0.42 | 0.42 | 0.42 | 0.41 |
| Gloss | 64 | 64 | 64 | 70 | 70 | 66 | 71 |
| Charpy, kJ/m² | 25 | 25 | 25 | 22 | 21 | 17 | 18 |
| MFR-1, g/10 min | 16 | 13 | 14 | 20 | 21 | 30 | 23 |

The components of the reaction mixture, reactor conditions, and product characterization are given in Table 7 below, unless otherwise noted amounts are in weight percent. In Table 7 and Tables hereinafter:

“N-PMI” is N-phenyl maleimide;

“Rubber-5” is a low cis polybutadiene rubber with a solution viscosity of about 160 mPas; and

“T-Profile” is the reactor temperature profile which consists of a starting temperature, “Start” and a fixed rate of temperature increase over time, “ΔT” given in ° C. per hour (° C./hr).

TABLE 7

| | | | COMPARATIVE | |
|---|---|---|---|---|
| | EXAMPLE | | EXAMPLE | |
| | 11 | 12 | I | J |
| REACTION COMPONENTS | | | | |
| Styrene | 50.8 | 51.7 | 50.8 | 51.7 |
| Ethylbenzene | 18.6 | 18.6 | 18.6 | 18.6 |
| Acrylonitrile | 18.5 | 18.5 | 18.5 | 18.5 |
| Rubber-5 | 11.2 | 11.2 | 11.2 | 11.2 |
| N-PMI | 0.9 | | 0.9 | |
| TRIGONOX 21, ppm | 70 | 70 | 70 | 70 |
| TRIGONOX 22, ppm | 100 | 100 | 100 | 100 |
| O-TEMPO, ppm | 40 | 40 | | |
| REACTOR CONDITIONS | | | | |
| T-Profile, 4.325° C./hr | | | | |
| 0 min., ° C. | 107 | 107 | 107 | 107 |
| 60 min., ° C. | 111 | 111 | 111 | 111 |
| 90 min., ° C. | 113 | 113 | 113 | 113 |
| 120 min., ° C. | 116 | 116 | 116 | 116 |
| 150 min., ° C. | 118 | 118 | 118 | 118 |
| 180 min., ° C. | 120 | 120 | 120 | 120 |
| 240 min., ° C. | 124 | 124 | 124 | 124 |
| 300 min., ° C. | 129 | 129 | 129 | 129 |
| 360 min., ° C. | 133 | 133 | 133 | 133 |
| 420 min., ° C. | 136 | 136 | 136 | 136 |
| PROCESS | | | | |
| CHARATERIZATION | | | | |
| z′ | | | | |
| 60 min., ° C. | 250861 | 1551739 | | |
| 90 min., ° C. | 201769 | 1225690 | | |
| 120 min., ° C. | 146117 | 864288 | | |
| 150 min., ° C. | 118139 | 686718 | | |
| 180 min., ° C. | 95712 | 546882 | | |
| 240 min., ° C. | 63201 | 349185 | | |
| 300 min., ° C. | 38035 | 201769 | | |
| 360 min., ° C. | 25553 | 131352 | | |
| 420 min., ° C. | 19054 | 95712 | | |
| PRODUCT | | | | |
| CHARATERIZATION | | | | |
| Solids, weight percent | | | | |
| 60 min. | 23.5 | 19.9 | 24.0 | 21.7 |
| 90 min. | 29.4 | 25.5 | 30.0 | 27.3 |
| 120 min. | 34.6 | 30.5 | 35.8 | 33.3 |
| 150 min. | 40.1 | 35.7 | 41.4 | 38.9 |
| 180 min. | 45.6 | 40.9 | 47.0 | 4.5 |
| 240 min. | 56.6 | 51.4 | 58.2 | 55.8 |
| 300 min. | 67.6 | 61.7 | 69.4 | 67.0 |
| 360 min. | 78.6 | 72.1 | 80.7 | 78.2 |
| 420 min. | 89.6 | 82.4 | 91.9 | 89.5 |

### Examples 13 to 24 and Comparative Examples K to M

Examples 13 to 24 and Comparative Examples K to M are carried out in a micro reactor comprising a closed glass capillary tube under a nitrogen atmosphere. Each reaction mixture size is about 1 mg in weight. The closed glass capillary tube is placed into a differential scanning calorimeter apparatus where a time-temperature sweep is applied (by electrical heating) and the extent of reaction is monitored by measuring the heat of reaction. The reaction mixtures comprise styrene monomer, optionally acrylonitrile monomer, an amount of a one weight percent mixture of O-TEMPO in ethylbenzene, and an amount of a one weight percent mixture of TRIGONOX 21 in ethylbenzene. The components of the reaction mixture are given in Table 8 below, unless otherwise noted amounts are given in parts by weight.

TABLE 8

| | COMPARATIVE | | | 1% O-TEMPO in | 1% TRIGONOX |
|---|---|---|---|---|---|
| EXAMPLE | EXAMPLE | Styrene | Acrylonitrile | EB solution | 21 in EB solution |
| | K | 97.5 | | | 2.5 |
| 13 | | 92.7 | | 4.9 | 2.4 |
| 14 | | 90.5 | | 4.8 | 4.8 |
| 15 | | 86.4 | | 4.5 | 9.1 |
| 16 | | 82.6 | | 4.3 | 13.0 |
| | L | 87.0 | 10.0 | | 3 |
| 17 | | 82.9 | 9.8 | 4.9 | 2.4 |
| 18 | | 81.0 | 9.5 | 4.8 | 4.8 |
| 19 | | 77.3 | 9.1 | 4.5 | 9.1 |
| 20 | | 73.9 | 8.7 | 4.3 | 13.0 |
| | M | 71.3 | 25.7 | | 3 |
| 21 | | 68.3 | 24.4 | 4.9 | 2.4 |
| 22 | | 66.7 | 23.8 | 4.8 | 4.8 |
| 23 | | 63.6 | 22.7 | 4.5 | 9.1 |
| 24 | | 60.9 | 21.7 | 4.3 | 13.0 |

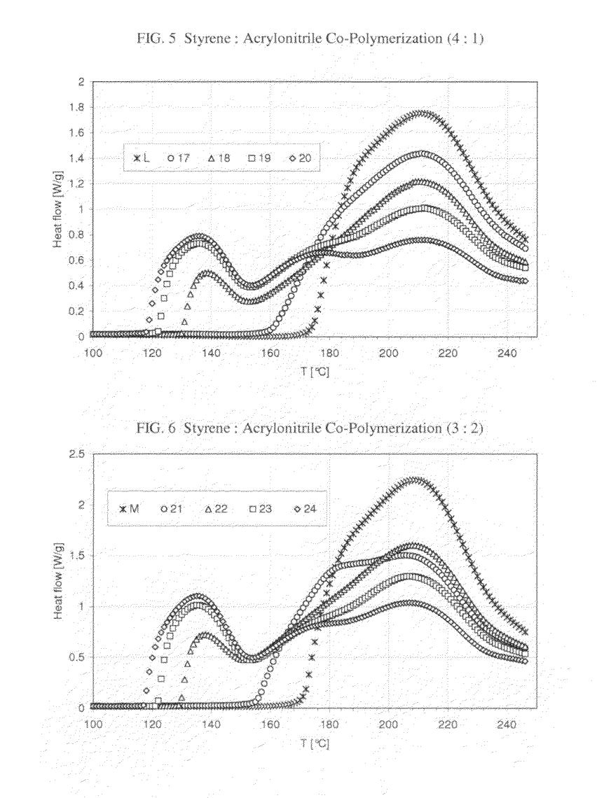

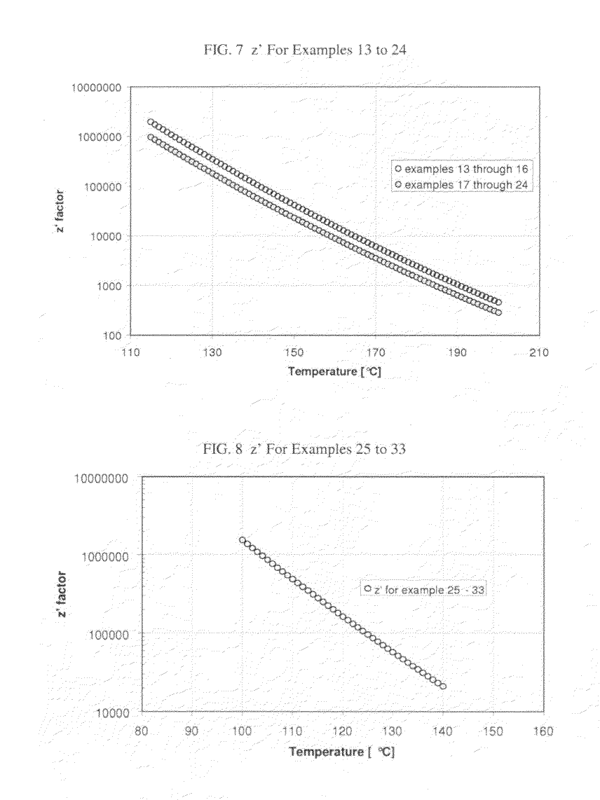

Polymerization is initiated and monitored over a temperature range from 35° C. to 170° C. A temperature profile of 10° C. per minute is applied. Polymerization activity is measured by heat flow from and to the capillary tube and reported graphically versus time in Watts per gram (W/g) in FIG. 4 to FIG. 6. The z′ values for Examples 13 to 24 are shown in FIG. 7.

### Examples 25 to 33

A macroinitiator according to Cianga, Ioan; Senyo, Takamichi; Ito, Koichi; Yagci, Yusuf., “Electron transfer reactions of radical anions with TEMPO: A versatile route for transformation of living anionic polymerization into stable radical-mediated polymerization”, Macromolecular Rapid Communications (2004), 25 (19), 1697-1702, is produced by dissolving potassium under anhydrous conditions and an oxygen atmosphere in a tetrahydrofuran (THF) solution of naphthalene. An amount of TEMPO is added to this potassium/naphthalene/THF solution. The final THF solution comprises 42 grams of 2,2,6,6-Tetramethylpiperidine-N-oxyl (TEMPO, available from Degussa A.G.), 10.8 grams of potassium, 120 grams of naphthalene, and 1700 ml of THF. This solution is transferred to a batch reactor. Propylene oxide and ethylene oxide are fed randomly into the reactor in a 2:98 ratio. The monomers are allowed to polymerize anionically under ambient conditions until a macroinitiator having a molecular weight of about 10,000 daltons is formed.

The macroinitiator solution is then dried to remove the THF, and the subsequent crystallization of the naphthalene is used to separate a naphthalene rich sediment from the macroinitiator fluid to yield close to 800 grams of macroinitiator. The macroinitiator is then split in two equal portions of about 400 grams. A first portion is treated with a bifunctional epoxy group containing bis-A based epoxide (DER 332 available from The Dow Chemical Company). 25 grams of DER 332 is added to the macroinitiator (approximately 1 mole of di-epoxide to 2 moles of macroinitiator). The mixture is heated to 70° C. in the presence of 0.25 percent by weight of a boron trifluoride etherate solution from Sigma Aldrich for one hour and cooled down. The resulting product is referred to as the macroinitiator-epoxy functionalized (MI-EF). The second portion is used as is after the naphthalene removal and is referred to as the macroinitiator (MI). The correction factor, c, is the same for MI-EF and MI.

Styrene monomer in ethylbenzene is polymerized with nDM, TRIGANOX 22 and either MI or MI-EF in a batch reactor as described hereinabove in Examples 11 to 12. The polymerization conditions are a 4 hour temperature profile ramping from 100° C. to 140° C. at 10° C./hr. The compositions of Examples 25 to 33 are described in Table 9. Unless otherwise noted, amounts are in parts by weight.

TABLE 9

| | EXAMPLE | | | | | | | | |
|---|---|---|---|---|---|---|---|---|---|
| COMPOSITION | 25 | 26 | 27 | 28 | 29 | 30 | 31 | 32 | 33 |
| Styrene | 40 | 55 | 50 | 55 | 50 | 55 | 50 | 55 | 50 |
| Ethylbenzene | 20 | 40 | 40 | 40 | 40 | 40 | 40 | 40 | 40 |
| nDM, ppm | 0 | 100 | 100 | 2000 | 2000 | 100 | 100 | 2000 | 2000 |
| TRIGANOX 22, ppm | 0 | 200 | 200 | 200 | 200 | 200 | 200 | 200 | 200 |
| MI | 44 | 5 | 10 | 5 | 10 | 0 | 0 | 0 | 0 |
| MI-EF | 0 | 0 | 0 | 0 | 0 | 5 | 10 | 5 | 10 |

The z′ values for Examples 25 to 33 calculated for the temperature ramp as described hereinabove are shown in FIG. 8.

### Example 34 and Comparative Example N

After reaction completion and devolatilization of Example 25 the composition of the final functionalized polystyrene material (PS-MI) is 51% MI and 49% PS. Example 34 is a composition comprising PS-MI (Example 25), polycarbonate (PC), and high impact polystyrene (HIPS). Comparative Example N is a composition comprising PC and HIPS. Example 34 and Comparative Example N are melt blended on a ZSK 25 twin screw extruder. Temperature zones applied are 280, 270, 270, 260, 260, 250, 240, 230° C. The melt temperature measured throughout the runs is 293° C.

The compositions and product characterization of Example 34 and Comparative Example N are described in Table 10. Unless otherwise noted, amounts are in parts by weight. In Table 10:

“PC” is a bisphenol-A polycarbonate with a melt flow rate (MFR) of 10 g/10 as determined at 300° C. and a load of 1.2 kg and is available as CALIBER™ 200-10 Polycarbonate Resin from The Dow Chemical Company;

“HIPS” is a high impact polystyrene comprising 8.5 weight percent butadiene rubber available as A-TECH™ 1200 Advanced Performance Polystyrene Resin from The Dow Chemical Company;

“PS-MI” is the functionalized polystyrene material from Example 25; and

“Izod” is notched and unnotched Izod impact resistance determined according to ASTM D256, results determined at 23° C. results are reported in J/m, results determined at −20° C. are reported as kilo Joules per square meter (kJ/m2).

TABLE 10

| | Example | Comparative Example |
|---|---|---|
| | 34 | N |
| COMPONENTS | | |
| PC | 79.2 | 80 |
| HIPS | 19.8 | 20 |
| PS-MI | 1.0 | — |
| PRODUCT CHARACTERIZATION | | |
| Izod Impact @ 23° C., J/m | 340 | 270 |
| Izod Impact @ −20 C. | | |
| Notched, kJ/m² | 7.4 | 6.6 |
| Unnotched, kJ/m² | 172 | 93 |
| Unnotched, bars broken, % | 20 | 70 |

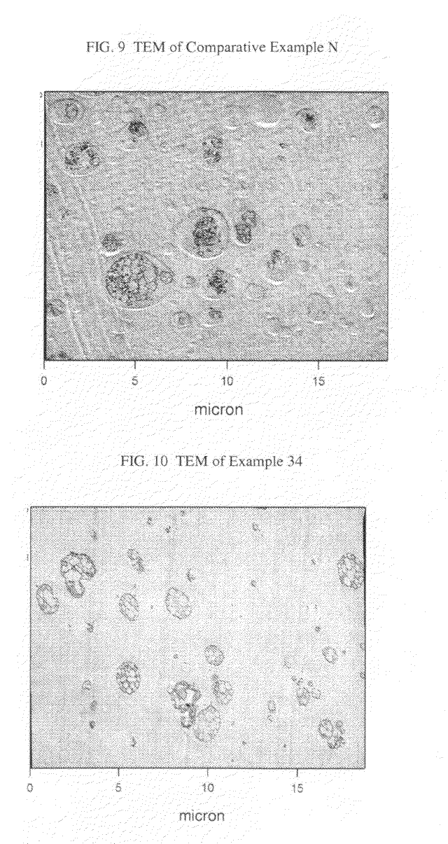

TEM analysis of Example 34 and Comparative Example N is performed on injection molded plaques. TEM's are taken from the core of the plaques, perpendicular to the flow direction at about 2 cm from the mold gate. The plaques are made at an injection molding temperature of 320° C. FIG. 9 is a TEM for Comparative Example N and shows the HIPS phase is discrete and discontinuous. FIG. 10 is a TEM for Example 34 and shows the HIPS domains are emulsified and are separated from the rubber particles in small sub-micron domains throughout the PC matrix phase.

### Examples 35 to 44 and Comparative Examples O to S

Pellets for Examples 35 to 44 and Comparative Examples O to S are prepared according to the process as described for Example 1 and Comparative Example A. The resulting polymer pellets are used to prepare physical property test specimens. The pellets are dried for two hours at 82° C. before molding. ASTM tensile bars are made on a 90 ton TOYO injection molding machine, with barrel temperatures of 480 249° C. and mold temperature of 60° C. Gloss measurements are made on 1.2×2.5×0.1 inch plaques that are made on a 28 ton Arburg injection molding machine with barrel temperatures ranging from 220° C. in the rear zone to 235° C. in the front zone, a mold temperature of 30° C., and a fill time of 0.68 seconds.

The components of the reaction mixture and reactor conditions are given in Table 11 below, unless otherwise noted amounts are in parts by weight. In Table 11 and Tables hereinafter:

“Recycle-3” is a mixture of 49.6 parts by weight ethyl benzene, 33.4 parts by weight styrene, and 15 parts by weight acrylonitrile;

“Recycle-4” is 100 parts by weight styrene; and

“Recycle-5” is a mixture of 65 parts by weight styrene and 35 parts by weight acrylonitrile.

Product characterization and property test results from injection molded test specimens for Examples 35 to 44 and Comparative Examples O to S are reported in Table 12. In Table 12 and Tables hereinafter:

“MFR-2” is melt flow rate determined according to ASTM D1238 on a Zwick 4105 01/03 plastometer at 230′C and an applied load of 3.8 kg, samples are conditioned at 80° C. for 2 hours before testing results are reported as g/10 min.

### Examples 45 to 50

Examples 45 to 50 are block copolymers comprising one or more styrene/butadiene (SB) block with one or more block comprising in addition to styrene (S) and butadiene (B), one or more of the following monomers: acrylonitrile (AN), N-phenylmaleimide (N-PMI), and/or alpha-methyl styrene (AMS). Pellets and test specimens for Examples 45 to 50 are produced according to the process as described for Examples 2 to 10, wherein the reactor temperatures which are listed are the average temperature for three zones comprising the reactor.

The components of the reaction mixture, additional feed streams, and reactor conditions are given in Table 13, unless otherwise noted amounts are in parts by weight. In Table 13 and Tables hereinafter:

“Rubber-6” is a low cis star branched polybutadiene with a solution viscosity of about 29 cSt available as ASAPRENE™ 720AX from Asahi.

TABLE 11

| | COMPARATIVE EXAMPLE | | | | | EXAMPLE | | |
|---|---|---|---|---|---|---|---|---|
| | O | P | Q | R | S | 35 | 36 | 37 |
| REACTION COMPONENTS | | | | | | | | |
| Styrene | 64.1 | 64.1 | 64.1 | 64.1 | 64.1 | 64.1 | 64.1 | 64.1 |
| Acrylonitrile | 12.3 | 12.3 | 12.3 | 12.3 | 12.3 | 12.3 | 12.3 | 12.3 |
| Ethylbenzene | 11.6 | 11.6 | 11.6 | 11.6 | 11.6 | 11.6 | 11.6 | 11.6 |
| Rubber-3 | 12 | 12 | 12 | 12 | 12 | 12 | 12 | 12 |
| Trigonox 21 to zone 1, ppm | 0 | 0 | 0 | 0 | 0 | 70 | 70 | 35 |
| Trigonox 22 to zone 1, ppm | 90 | 0 | 0 | 0 | 0 | 90 | 90 | 90 |
| O-TEMPO to zone 1, ppm | 0 | 0 | 0 | 0 | 0 | 38 | 38 | 19 |
| nDM to zone 2, ppm | 200 | 200 | 200 | 200 | 200 | 0 | 0 | 0 |
| nDM to zone 4, ppm | 2222 | 2222 | 3667 | 1111 | 1111 | 1111 | 1111 | 1111 |
| Recycle-3 to zone 4, g/h | 70 | 70 | 70 | 70 | 70 | 70 | 70 | 70 |
| Recycle-4 to zone 6, g/h | 66.4 | 66.4 | 66.4 | 66.4 | 66.4 | 0 | 0 | 0 |
| Recycle-5 to zone 6, g/h | 0 | 0 | 0 | 0 | 0 | 66.4 | 66.4 | 66.4 |
| IRGANOX 1076 | 0.2 | 0.2 | 0.2 | 0.2 | 0.2 | 0.2 | 0.2 | 0.2 |
| REACTOR CONDITIONS | | | | | | | | |
| Feed Rate, g/h | 630 | 630 | 630 | 630 | 630 | 630 | 630 | 630 |
| Temperature, ° C. | | | | | | | | |
| Zone 1 | 106 | 106 | 106 | 106 | 106 | 106 | 109 | 109 |
| Zone 2 | 113 | 113 | 113 | 113 | 113 | 113 | 116 | 116 |
| Zone 3 | 121 | 121 | 121 | 121 | 121 | 121 | 124 | 124 |
| Zone 4 | 128 | 128 | 128 | 128 | 128 | 128 | 128 | 128 |
| Zone 5 | 137 | 137 | 137 | 137 | 137 | 137 | 137 | 137 |
| Zone 6 | 147 | 147 | 147 | 147 | 147 | 147 | 147 | 147 |
| Zone 7 | 155 | 155 | 155 | 155 | 155 | 155 | 155 | 155 |
| Zone 8 | 165 | 165 | 165 | 165 | 165 | 165 | 165 | 165 |
| Zone 9 | 170 | 170 | 170 | 170 | 170 | 170 | 170 | 170 |
| Agitation, rpm | | | | | | | | |
| Reactor 1 | 175 | 175 | 175 | 175 | 155 | 148 | 175 | 175 |
| Reactor 2 | 160 | 160 | 160 | 160 | 140 | 132 | 160 | 160 |
| Reactor 3 | 30 | 30 | 30 | 30 | 30 | 30 | 30 | 30 |
| Devo-1, ° C. | 235 | 235 | 235 | 235 | 235 | 235 | 235 | 235 |

| | EXAMPLE | | | | | | |
|---|---|---|---|---|---|---|---|
| | 38 | 39 | 40 | 41 | 42 | 43 | 44 |
| REACTION COMPONENTS | | | | | | | |
| Styrene | 64.1 | 64.1 | 64.1 | 64.1 | 64.1 | 64.1 | 64.1 |
| Acrylonitrile | 12.3 | 12.3 | 12.3 | 12.3 | 12.3 | 12.3 | 12.3 |
| Ethylbenzene | 11.6 | 11.6 | 11.6 | 11.6 | 11.6 | 11.6 | 11.6 |
| Rubber-3 | 12 | 12 | 12 | 12 | 12 | 12 | 12 |
| Trigonox 21 to zone 1, ppm | 35 | 35 | 35 | 35 | 35 | 35 | 35 |
| Trigonox 22 to zone 1, ppm | 90 | 90 | 90 | 90 | 90 | 90 | 90 |
| O-TEMPO to zone 1, ppm | 14 | 14 | 14 | 14 | 14 | 14 | 14 |
| nDM to zone 2, ppm | 0 | 0 | 0 | 150 | 150 | 300 | 300 |
| nDM to zone 4, ppm | 1111 | 2222 | 4444 | 2222 | 2222 | 1111 | 1667 |
| Recycle-3 to zone 4, g/h | 70 | 70 | 70 | 70 | 70 | 70 | 70 |
| Recycle-4 to zone 6, g/h | 0 | 0 | 0 | 0 | 0 | 0 | 0 |
| Recycle-5 to zone 6, g/h | 66.4 | 66.4 | 66.4 | 66.4 | 66.4 | 66.4 | 66.4 |
| IRGANOX 1076 | 0.2 | 0.2 | 0.2 | 0.2 | 0.2 | 0.2 | 0.2 |
| REACTOR CONDITIONS | | | | | | | |
| Feed Rate, g/h | 630 | 630 | 630 | 630 | 630 | 630 | 630 |
| Temperature, ° C. | | | | | | | |
| Zone 1 | 106 | 106 | 106 | 106 | 106 | 106 | 106 |
| Zone 2 | 113 | 113 | 113 | 113 | 113 | 113 | 113 |
| Zone 3 | 121 | 121 | 121 | 121 | 121 | 121 | 121 |
| Zone 4 | 128 | 128 | 128 | 128 | 128 | 128 | 128 |
| Zone 5 | 137 | 137 | 137 | 137 | 137 | 137 | 137 |
| Zone 6 | 147 | 147 | 147 | 147 | 147 | 147 | 147 |
| Zone 7 | 155 | 155 | 155 | 155 | 155 | 155 | 155 |
| Zone 8 | 165 | 165 | 165 | 165 | 165 | 165 | 165 |
| Zone 9 | 170 | 170 | 170 | 170 | 170 | 170 | 170 |
| Agitation, rpm | | | | | | | |
| Reactor 1 | 175 | 175 | 175 | 175 | 148 | 148 | 148 |
| Reactor 2 | 160 | 160 | 160 | 160 | 132 | 132 | 132 |
| Reactor 3 | 30 | 30 | 30 | 30 | 30 | 30 | 30 |
| Devo-1, ° C. | 235 | 235 | 235 | 235 | 235 | 235 | 235 |

TABLE 12

| | COMPARATIVE EXAMPLE | | | | | EXAMPLE | | |
|---|---|---|---|---|---|---|---|---|
| | O | P | Q | R | S | 35 | 36 | 37 |
| PROCESS CHARATERIZATION | | | | | | | | |
| z′ | | | | | | | | |
| Zone 1 | | | | | | 2828435 | 2828435 | 2828435 |
| Zone 2 | | | | | | 1225690 | 1225690 | 1225690 |
| Zone 3 | | | | | | 488451 | 488451 | 488451 |
| Zone 4 | | | | | | 224920 | 224920 | 224920 |
| Zone 5 | | | | | | 86215 | 86215 | 86215 |
| Zone 6 | | | | | | 31147 | 31147 | 31147 |
| Zone 7 | | | | | | 14265 | 14265 | 14265 |
| Zone 8 | | | | | | 5591 | 5591 | 5591 |
| Zone 9 | | | | | | 3555 | 3555 | 3555 |
| PRODUCT | | | | | | | | |
| CHARACTERIZATION | | | | | | | | |
| Solids, weight percent | | | | | | | | |
| Reactor 1 | 45.2 | 34.1 | 34.9 | 33.7 | 33.8 | 31.2 | 35.9 | 38.3 |
| Reactor 2 | 57.1 | 52.5 | 52.2 | 52.2 | 52.8 | 48.1 | 52.5 | 53.9 |
| Reactor 3 | 77.0 | 76.1 | 75.2 | 75.1 | 75.4 | 74.2 | 75.2 | 75.6 |
| Mn, g/mole | | | | | | | | |
| Reactor 1 | 128,300 | 131,900 | 130,800 | 136,000 | 133,400 | 123,700 | 126,700 | 140,700 |
| Reactor 2 | 50,800 | 51,300 | 36,800 | 67,700 | 86,200 | 66,500 | 69,300 | 70,100 |
| Extruded Product | 47,300 | 45,100 | 35,500 | 56,600 | 56,800 | 49,200 | 50,500 | 50,900 |
| Mw, g/mole | | | | | | | | |
| Reactor 1 | 249,700 | 253,600 | 252,800 | 256,300 | 254,500 | 238,400 | 236,300 | 266,300 |
| Reactor 2 | 175,300 | 152,800 | 145,100 | 168,000 | 172,000 | 166,100 | 174,500 | 192,000 |
| Extruded Product | 139,300 | 122,400 | 113,400 | 137,000 | 138,500 | 126,600 | 133,400 | 143,000 |
| LS-230 RPS, micrometer | | | | | | | | |
| Extruded Product, Mean | 2.43 | 1.58 | 1.59 | 1.37 | 1.50 | 9.30 | 8.86 | 5.81 |
| Gloss | 28.4 | 32.3 | 30.5 | 36.4 | 31.9 | 15.9 | 16.9 | 17.7 |
| Izod, J/m | 148.2 | 84.5 | 51.5 | 123.6 | 132.7 | 79.2 | 93.6 | 91.0 |
| MFR-2 @230° C./3.8 kg, g/10 min | 7.63 | 13.07 | 19.96 | 7.68 | 7.33 | 8.60 | 8.06 | 6.95 |

| | EXAMPLE | | | | | | |
|---|---|---|---|---|---|---|---|
| | 38 | 39 | 40 | 41 | 42 | 43 | 44 |
| PROCESS CHARATERIZATION | | | | | | | |
| z′ | | | | | | | |
| Zone 1 | 2828435 | 2828435 | 2828435 | 2828435 | 2828435 | 2828435 | 2828435 |
| Zone 2 | 1225690 | 1225690 | 1225690 | 1225690 | 1225690 | 1225690 | 1225690 |
| Zone 3 | 488451 | 488451 | 488451 | 488451 | 488451 | 488451 | 488451 |
| Zone 4 | 224920 | 224920 | 224920 | 224920 | 224920 | 224920 | 224920 |
| Zone 5 | 86215 | 86215 | 86215 | 86215 | 86215 | 86215 | 86215 |
| Zone 6 | 31147 | 31147 | 31147 | 31147 | 31147 | 31147 | 31147 |
| Zone 7 | 14265 | 14265 | 14265 | 14265 | 14265 | 14265 | 14265 |
| Zone 8 | 5591 | 5591 | 5591 | 5591 | 5591 | 5591 | 5591 |
| Zone 9 | 3555 | 3555 | 3555 | 3555 | 3555 | 3555 | 3555 |
| PRODUCT CHARACTERIZATION | | | | | | | |
| Solids, weight percent | | | | | | | |
| Reactor 1 | 37.3 | 37.7 | 37.5 | 37 | 36.5 | 35.4 | 34.8 |
| Reactor 2 | 56.6 | 55.6 | 52.8 | 52 | 53.6 | 52.4 | 52.6 |
| Reactor 3 | 74.3 | 74.1 | 75.4 | 76.4 | 74.1 | 76.5 | 76.1 |
| Mn, g/mole | | | | | | | |
| Reactor 1 | 157,100 | 158,000 | 150,100 | 125,200 | 134,600 | 107,200 | 108,700 |
| Reactor 2 | 72,900 | 49,800 | 34,900 | 51,700 | 56,100 | 63,400 | 55,300 |
| Extruded Product | 55,500 | 45,600 | 31,400 | 43,000 | 44,800 | 49,800 | 45,600 |
| Mw, g/mole | | | | | | | |
| Reactor 1 | 290,200 | 296,000 | 285,000 | 239,600 | 247,700 | 211,900 | 215,000 |
| Reactor 2 | 196,800 | 184,300 | 173,500 | 154,800 | 158,900 | 150,700 | 144,800 |
| Extruded Product | 154,600 | 143,200 | 128,000 | 101,400 | 125,000 | 121,500 | 113,000 |
| LS-230 RPS, micrometer | | | | | | | |
| Extruded Product, Mean | 0.92 | 0.81 | 0.80 | 1.15 | 1.08 | 4.89 | 2.64 |
| Gloss | 54.4 | 64.4 | 65.2 | 48.9 | 44.4 | 21.4 | 19.2 |
| Izod, J/m | 186.2 | 139.6 | 74.4 | 124.1 | 117.2 | 133.8 | 113.4 |
| MFR-2 @230° C./3.8 kg, g/10 min | 5.48 | 9.14 | 15.10 | 11.60 | 11.16 | 8.42 | 10.11 |

TABLE 13

| | EXAMPLE | | | | | |
|---|---|---|---|---|---|---|
| | 45 | 46 | 47 | 48 | 49 | 50 |
| REACTION COMPONENTS | | | | | | |
| Feed into zone 1 | | | | | | |
| Feed Rate, g/h | 800 | 901 | 892 | 965 | 900 | 900 |
| Styrene | 70 | 74 | 74 | 74 | 74 | 74 |
| Ethylbenzene | 10 | 10 | 10 | 10 | 10 | 10 |
| Rubber-4 | 20 | | 16 | | 12 | 12 |
| Rubber-6 | | | | | 4 | 4 |
| Rubber-7 | | 16 | | | | |
| Rubber-8 | | | | 16 | | |
| Trigonox 22, ppm | | 50 | 50 | 50 | 50 | 50 |
| O-TEMPO, ppm | 450 | 400 | 600 | 600 | 600 | 600 |
| Feed into zone 4 | | | | | | |
| Styrene, g/hr | | 90 | 80 | | | |
| Acrylonitrile, g/hr | | 120 | 90 | 80 | 80 | 180 |
| Feed to zone 7 | | | | | | |
| Styrene, g/hr | 100 | | | | | |
| Acrylonitrile, g/hr | 160 | 100 | 140 | 175 | 50 | |
| Ethylbenzene, g/hr | | 100 | 200 | 200 | | 100 |
| N-phenylmaleimide, g/hr | | | 60 | 75 | | |
| Alpha-methyl styrene, g/hr | | | | | 100 | |
| Feed to zone 10 | | | | | | |
| Ethylbenzene, g/hr | 150 | | | | 100 | |
| Acrylonitrile, g/hr | | | | | 100 | |
| REACTOR CONDITIONS | | | | | | |
| Temperature, ° C. | | | | | | |
| Reactor 1 | 132 | 132 | 132 | 132 | 132 | 132 |
| Reactor 2 | 132 | 131 | 131 | 125 | 126 | 124 |
| Reactor 3 | 126 | 131 | 131 | 128 | 128 | 128 |
| Reactor 4 | 150 | 150 | 145 | 140 | 136 | 136 |

“Rubber-7” is a low cis linear styrene/butadiene block rubber having 15% styrene with a solution viscosity of 35 cSt available as SOLPRENE 1110 from Housmex; and

“Rubber-8” is a low cis linear styrene/butadiene block rubber having 40% styrene with a solution viscosity of 44 cSt available as SOLPRENE 1430 from Housmex.

The polymerization characteristics for Examples 45 to 50 are given in Table 14. The following properties are given for each example: polymerization yield, polymerization rate, number average molecular weight (Mn), and molecular weight distribution (Mw/Mn).

TABLE 14

| | EXAMPLE | | | | | |
|---|---|---|---|---|---|---|
| | 45 | 46 | 47 | 48 | 49 | 50 |
| PROCESS CHARATERIZATION | | | | | | |
| z′ | | | | | | |
| Reactor 1 | 279945 | 279945 | 279945 | 279945 | 279945 | 279945 |
| Reactor 2 | 279945 | 162627 | 162627 | 312569 | 279945 | 349185 |
| Reactor 3 | 279945 | 162627 | 31147 | 42061 | 146117 | 224920 |
| Reactor 4 | 23161 | 23161 | 8091 | 12964 | 63201 | 95712 |
| POLYMERIZATION CHARATERISTICS | | | | | | |
| Reactor 1 | | | | | | |
| Polymerization yield, % | 10.9 | 13.1 | 8.6 | 8.2 | 8.1 | 8.3 |
| Polymerization rate, %/hr | 3.6 | 4.9 | 3.2 | 3.3 | 3.0 | 3.1 |
| Mn, kg/mole | 45 | 51.1 | 33 | 34.8 | 28.9 | 30.3 |
| Mw/Mn | 1.6 | 1.6 | 1.5 | 1.5 | 1.5 | 1.5 |
| Reactor 2 | | | | | | |
| Polymerization yield, % | 26.6 | 29.4 | 34.1 | 22.7 | 27.7 | 25.2 |
| Polymerization rate, %/hr | 5.2 | 7.6 | 11.4 | 6.3 | 8.1 | 7.6 |
| Mn, kg/mole | 63 | 82 | 71 | 60 | 58 | 64 |
| Mw/Mn | 1.7 | 1.8 | 2.1 | 1.6 | 1.6 | 1.7 |
| Reactor 3 | | | | | | |
| Polymerization yield, % | 41.1 | 41.7 | 45.7 | 41.0 | 42.3 | 39.1 |
| Polymerization rate, %/hr | 6.4 | 6.6 | 6.8 | 11.0 | 6.9 | 6.7 |
| Mn, kg/mole | 81 | 94 | 70 | 72 | 65 | 80 |
| Mw/Mn | 1.8 | 2.0 | 1.9 | 1.8 | 1.9 | 1.8 |
| Reactor 4 | | | | | | |
| Polymerization yield, % | 63.3 | 69.5 | 68.4 | 62.6 | 59.1 | 62.0 |
| Polymerization rate, %/hr | 11.2 | 15.3 | 13.9 | 13.5 | 9.4 | 11.3 |
| Mn, kg/mole | 59 | 64 | 59 | 65 | 50 | 62 |
| Mw/Mn | 2.5 | 2.5 | 2.1 | 2.1 | 2.4 | 2.3 |

Examples 45 to 50 are characterized by high pressure liquid chromatography (HPLC). The following test method is used:
Column Hypersil CPS, 100×4.6 mm; flow 1.0 ml/min
Mobile phase: 80% Heptane/20% THF gradually changing into 100% THF in 10 min and hold for 5 min
Injection volume=10 microliters
Detection UV254 nm (bandwidth 100 nm)
Reference wavelength=275 nm (bandwidth 100 nm)
Sample preparation: 0.25 wt % in THF

The HPLC chromatogram gives different peaks each having two parameters: the retention time (RT) and the peak area (PA). Polymers having a higher polarity because of higher acrylonitrile or N-phenylmaleimide content have a higher retention time. The peak area is a measure for the amount of polymer. The polarity response function that relates the acrylonitrile content (AN) with the retention time of the calibration series is:

AN=−4.63−1.5×RT+0.60×RT̂2.

Polarity of the polymers is defined as follows: low, medium and high polarity is defined by an apparent AN content being below 10 percent, between 10 and 20 percent, and above 20 percent, respectively. The response factor that relates the peak area with the amount of polymer depends on the retention time since a UV detector is used that detects the amount of styrene and is insensitive to the amount of AN. This relative mass response function (RM) is obtained from the calibration series:

RM=−3.60*RT+47.3

Dividing the PA by the RM we get the normalized peak area (NPA) that can be used for calculating the composition:

NPA=PA/RM

Examples 45 to 50 give HPLC chromatograms with multiple peaks. Using the polarity response function, the different peaks are classified into a polarity class, Table 15. Using the normalized peak area, the composition of the matrix can be calculated, for example the chromatogram contains three peaks classified into three classes based on the polarity response function: low polarity (l), medium polarity (m) and high polarity (h). Each peak has a normalized peak area: NPA(l), NPA(m) and NPA(h). Therefore the percentage low polarity polymer is then:

NPA(l)/[(NPA(l)+NPA(m)+NPA(h)]

TABLE 15

| | EXAMPLE | | | | | |
|---|---|---|---|---|---|---|
| HPLC CLASSIFICATION, % | 45 | 46 | 47 | 48 | 49 | 50 |
| Low polarity | 14 | 0 | 2 | 2 | 0 | 0 |
| Medium polarity | 0 | 23 | 19 | 0 | 47 | 0 |
| High polarity | 86 | 77 | 79 | 98 | 53 | 100 |

Examples 45 to 50 contain block copolymer that have segments belonging to different polarity classes. The nature of the HPLC separation is such that the peak appears at the retention time associated with the segment with the highest polarity. Therefore, a block-copolymer with a low and medium polarity segment is classified as medium polarity polymer.

Table 16 shows the polymerization yield by polarity of polymers and made per reactor for Examples 45 to 50. Table 16 also shows fractional percent of polymer made in each reactor based on 100 percent of final product. The values in Table 16 are determined taking into account the additional acrylonitrile and/or other monomers added to the sequential reactors.

TABLE 16

| | EXAMPLE | | | | | |
|---|---|---|---|---|---|---|
| | 45 | 46 | 47 | 48 | 49 | 50 |
| POLYMERIZATION | | | | | | |
| YIELD, % | | | | | | |
| Reactor 1 | | | | | | |
| Only styrene | 10.9 | 13.1 | 8.6 | 8.2 | 8.1 | 8.3 |
| Low amount of acrylonitrile | | | | | | |
| High amount of acrylonitrile | | | | | | |
| Very high amount of | | | | | | |
| acrylonitrile | | | | | | |
| Reactor 2 | | | | | | |
| Only styrene | 16 | | | | | |
| Low amount of acrylonitrile | | 16 | 26 | 15 | 20 | |
| High amount of acrylonitrile | | | | | | 17 |
| Very high amount of | | | | | | |
| acrylonitrile | | | | | | |
| Reactor 3 | | | | | | |
| Only styrene | | | | | | |
| Low amount of acrylonitrile | | | | | | |
| High amount of acrylonitrile | 15 | 12 | 12 | 18 | 15 | 14 |
| Very high amount of | | | | | | |
| acrylonitrile | | | | | | |
| Reactor 4 | | | | | | |
| Only styrene | | | | | | |
| Low amount of acrylonitrile | | | | | | |
| High amount of acrylonitrile | 22 | 28 | 23 | 22 | | 23 |
| Very high amount of | | | | | 17 | |
| acrylonitrile | | | | | | |
| Overall yield | 63 | 70 | 68 | 63 | 59 | 62 |
| FINAL PRODUCT | | | | | | |
| COMPOSITION, % | | | | | | |
| Reactor 1 | 17 | 19 | 13 | 13 | 14 | 13 |
| Reactor 2 | 25 | 23 | 37 | 23 | 33 | 27 |
| Reactor 3 | 23 | 18 | 17 | 29 | 25 | 22 |
| Reactor 4 | 35 | 40 | 33 | 34 | 28 | 37 |
| Total | 100 | 100 | 100 | 100 | 100 | 100 |

Combining the HPLC classifications from Table 15 with the compositional makeup from Table 16, the following conclusions can be drawn, Table 17:

TABLE 17

| EX- | Minimum | |
|---|---|---|
| AM- | PS | |
| PLE | block, % | |
| 45 | 28 | 42% styrene is polymerized before the composition |
| | | change. 14% is detected as PS (low p). Therefore, 42 − |
| | | 14 = 28% remains living and continues polymerization |
| | | in Reactor 3 becoming a S/AN block polymer. |
| 46 | 19 | 19% styrene is polymerized in Reactor 1 but no PS is |
| | | found on the HPLC, so all remains living and becomes |
| | | a S/AN block polymer in Reactor 2 which has a |
| | | medium AN level. |
| 47 | 11 | 13% styrene is polymerized in Reactor 1 and 2% PS is |
| | | found, so at least 11% stays living and grows further |
| | | as a S/AN block copolymer in Reactor 2. 19% |
| | | medium polar polymer is found while 37% polymer |
| | | medium polar polymer is made in the Reactor 2. |
| | | Therefore, at least 37 − 19 = 18% is living when |
| | | entering the Reactor 3 which has a higher AN content |
| | | producing a di and/or tri-block copolymer. |
| 48 | 11 | 13% styrene is polymerized in Reactor 1 and only 2% |
| | | PS is found, so at least 11% stays living and becomes |
| | | a S/AN block copolymer in Reactor 2. All 23% |
| | | polymer with medium polarity made in Reactor 2 |
| | | becomes part of a high polar block copolymer, this |
| | | means that all 11% PS block as grown further into a |
| | | triple block with a high polarity end. So the minimum |
| | | amount of (tri)-block is 11 + 23 = 34%. |
| 49 | 14 | 14% styrene is polymerized in Reactor 1 and no PS is |
| | | found, so at least 14% becomes a S/AN block |
| | | copolymer in Reactor 2. Reactor 1 and Reactor 2 |
| | | together had make 47% which is the amount of |
| | | medium polarity polymer produced overall. This |
| | | means the living nature of the polymer in Reactor 2 |
| | | ceased to exist by the time the polymers enter Reactor |
| | | 3. Otherwise, if no termination occurs they would |
| | | become a high polar polymer. |
| 50 | 13 | 13% styrene is polymerized in Reactor 1 and no PS is |
| | | found, so all stays living and enters Reactor 2 |
| | | becoming a S/AN block copolymer. At least 13% is a |
| | | block copolymer with a low polar polystyrene block. |

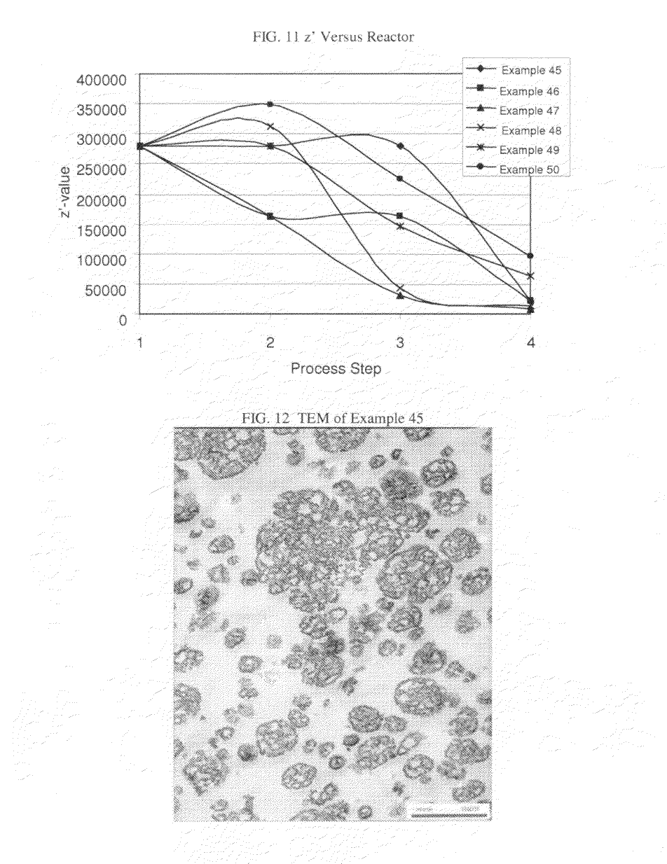

FIG. 11 graphically represents z′ values versus reactor location for Examples 45 to 50.

Product characterization and property test results on injection molded samples for Examples 45 to 50 are reported in Table 18. In Table 18:

“MFR-3” is melt flow rate determined according to ASTM D1238 on a Zwick 4105 01/03 plastometer at 220° C. and an applied load of 10 kg and

“Tensile Yield”, “Tensile Elongation at Break”, and Tensile Modulus” is performed in accordance with ISO 527-2. Tensile Type 1 test specimens are conditioned at 23° C. and 50 percent relative humidity 24 hours prior to testing. Testing is performed at 23° C. using a Zwick 1455 mechanical tester. Tensile Yield and Modulus are reported in mega Pascals (MPa) and Tensile elongation is reported in percent (%).

TABLE 18

| | EXAMPLE | | | | | |
|---|---|---|---|---|---|---|
| | 45 | 46 | 47 | 48 | 49 | 50 |
| PRODUCTT CHARATERIZATION | | | | | | |
| RPS, micrometer | 0.93 | 0.47 | 0.58 | 0.51 | 0.92 | 0.44 |
| PHYSICAL PROPERTIES at | | | | | | |
| MFR-3@220 C/10 kg, g/10 min | 6 | 10 | 8 | 7 | 16 | 5 |
| Notched Izod, kJ/m² | 36 | 5 | 14 | 3 | 19 | 12 |
| Gloss, % | 16 | 54 | 64 | 62 | 14 | 59 |
| Tensile strength, MPa | 42 | 49 | 48 | 58 | 38 | 35 |
| Tensile Elongation, at Break % | 10 | 4 | 5 | 4 | 19 | 4 |
| Tensile Modulus, MPa | 2199 | 2355 | 2336 | 2725 | 1946 | 2266 |
| Vicat, ° C. | | | 103 | 105 | 97 | 97 |

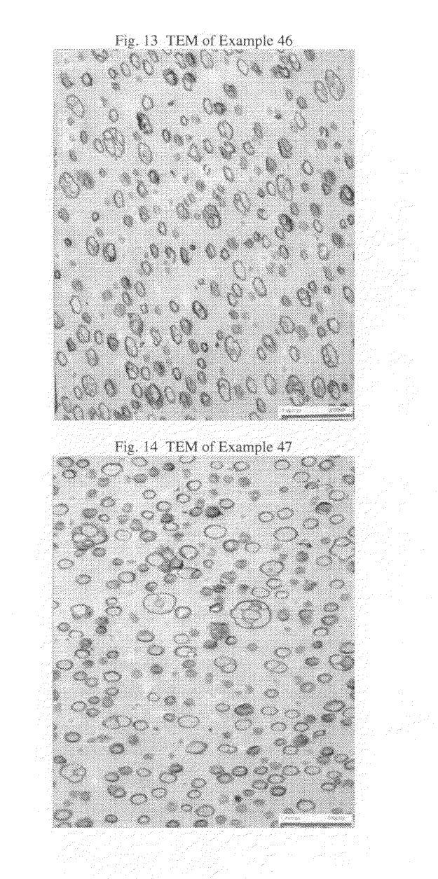

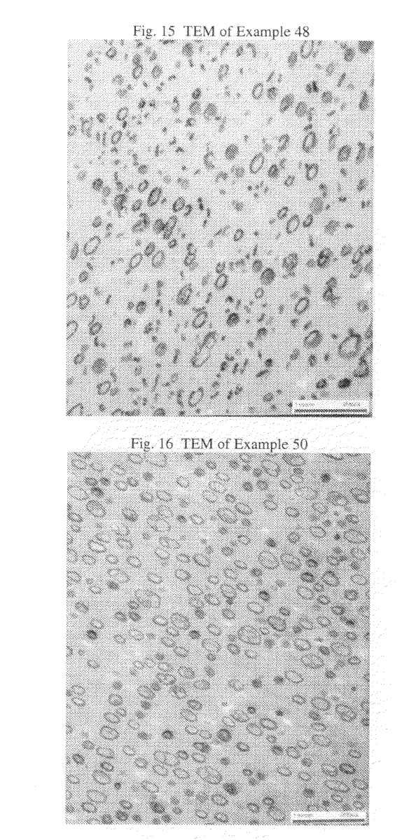

FIG. 12 to FIG. 16 are transmission electron micrographs (TEMs) from injection molded samples of Examples 45 to 48 and 50, respectively.

1. A multistage process for the preparation of a (co)polymer composition comprising the steps of:
i) polymerizing in a first stage a reaction mixture comprising
a) one or more monomer with one or more unsaturated bond;
b) optionally, one or more rubber;
c) optionally, one or more comonomer;
d) optionally, one or more polymerization initiator;
e) optionally, one or more chain transfer agent;
f) optionally one or more decomposition catalyst; and
g) optionally, a solvent
in the presence of one or more stable free radical and/or one or more stable free radical precursor which provides a stable free radical during the polymerization process such that the polymerization proceeds via a stable free radical polymerization process until a partial conversion of monomer(s) to (co)polymer is obtained and
ii) polymerizing in a second stage the partially converted reaction mixture under reaction conditions that proceed via a free radical polymerization process to obtain a further degree of conversion of monomer(s) to (co)polymer.

2. The process of claim 1 wherein the monomer is a vinylidene monomer, diene monomer, olefinic monomer, allylic monomer, vinyl monomer, or mixtures thereof.

3. The process of claim 1 wherein the monomer is a vinyl aromatic monomer.

4. The process of claim 1 further comprising the step of:
iii) preparing the one or more stable free radical precursor in a third stage under reaction conditions that proceed via an anionic polymerization mechanism.

5. The process of claim 3 comprises one or more rubber wherein the polymerization process is a mass, bulk, mass-suspension, or mass-solution process.

6. The process of claim 5 further comprising the step of
iv) subjecting the resultant mixture of desired degree of conversion to conditions sufficient to remove any unreacted monomer(s) and optional solvent and to cross-link the rubber.
The process of claim 5 wherein the vinyl aromatic monomer is styrene and the rubber is a 1,3-butadiene based rubber.

8. The process of claim 7 comprises the polymerization initiator dibenzoyl peroxide; 1,1-di(t-butyl peroxy)cyclohexane; t-butyl peroxy 2-ethyl hexanoate; or mixtures thereof.

9. The process of claim 7 comprises the chain transfer agent methyl styrene dimer, n-dodecylmercaptan, terpinoline, thioglycolate, fatty esters of linoleic acid, fatty esters of linolic acid, linseed oil, or mixtures thereof.

10. The process of claim 8 comprises the chain transfer agent methyl styrene dimer, n-dodecylmercaptan, terpinoline, thioglycolate, fatty esters of linoleic acid, fatty esters of linolic acid, linseed oil, or mixtures thereof.

11. The process of claim 7 comprises the comonomer acrylonitrile.

12. The process of claim 11 comprises the polymerization initiator dibenzoyl peroxide; 1,1-di(t-butyl peroxy)cyclohexane; t-butyl peroxy 2-ethyl hexanoate; or mixtures thereof.

13. The process of claim 11 comprises the chain transfer agent methyl styrene dimer, n-dodecylmercaptan, terpinoline, thioglycolate, fatty esters of linoleic acid, fatty esters of linolic acid, linseed oil, or mixtures thereof.

14. The process of claim 12 comprises the chain transfer agent methyl styrene dimer, n-dodecylmercaptan, terpinoline, thioglycolate, fatty esters of linoleic acid, fatty esters of linolic acid, linseed oil, or mixtures thereof.

15. The process of claims 3, 4, 5, 6, 7, 8, 9, 10, 11, 12, 13, 14 comprises the solvent ethylbenzene.

16. The process of claim 1, 2, 3, 4, 5, 6, 7, 8, 9, 10, 11, 12, 13, or 14 wherein the stable free radical comprises an ═N—O. group.

17. The process of claim 15 wherein the stable free radical comprises an ═N—O. group.

18. The process of claim 16 wherein the stable free radical is 2,2,6,6-tetramethyl-1-piperindinyloxy, 4-oxo-2,2,6,6-tetramethyl-1-piperindinyloxy, 4-hydroxy-2,2,6,6-tetramethyl-1-piperindinyloxy, or mixtures thereof.

19. The process of claim 17 wherein the stable free radical is 2,2,6,6-tetramethyl-1-piperindinyloxy, 4-oxo-2,2,6,6-tetramethyl-1-piperindinyloxy, 4-hydroxy-2,2,6,6-tetramethyl-1-piperindinyloxy, or mixtures thereof.
A multistage process for the preparation of a (co)polymer composition comprising the steps of:
i) polymerizing in a 1^{st} polymerization stage a reaction mixture comprising
a) one or more monomer with one or more unsaturated bond;
b) optionally one or more rubber;
c) optionally, one or more comonomer;
d) optionally, one or more polymerization initiator;
e) optionally, one or more chain transfer agent;
f) optionally one or more decomposition catalyst; and
g) optionally, a solvent
in the presence of one or more stable free radical and/or one or more stable free radical precursor which provides a stable free radical during the polymerization until a partial conversion of (co)monomer to (co)polymer is obtained and
ii) polymerizing in a 2^{nd} polymerization stage wherein the partially converted reaction mixture proceeds to a further degree of conversion of (co)monomer to (co)polymer
wherein the 1^{st} polymerization stage has a mediation constant, z′, greater than 150,000 and the 2^{nd} polymerization stage has a z′ of less than 150,000.

21. The process of claim 20 wherein the monomer is a vinylidene monomer, diene monomer, olefinic monomer, allylic monomer, vinyl monomer, or mixtures thereof.

22. The process of claim 21 wherein the monomer is a vinyl aromatic monomer.

23. The process of claim 20 further comprising the step of:
iii) preparing the one or more stable free radical precursor in a third stage under reaction conditions that proceed via an anionic polymerization mechanism.

24. The process of claim 22 comprises one or more rubber wherein the polymerization process is a mass, bulk, mass-suspension, or mass-solution process.

25. The process of claim 22 further comprising the step of
iv) subjecting the resultant mixture of desired degree of conversion to conditions sufficient to remove any unreacted monomer(s) and optional solvent and to cross-link the rubber.
The process of claim 22 wherein the vinyl aromatic monomer is styrene and the rubber is a 1,3-butadiene based rubber.

27. The process of claim 26 comprises the polymerization initiator dibenzoyl peroxide; 1,1-di(t-butyl peroxy)cyclohexane; t-butyl peroxy 2-ethyl hexanoate; or mixtures thereof.

28. The process of claim 26 comprises the chain transfer agent methyl styrene dimer, n-dodecylmercaptan, terpinoline, thioglycolate, fatty esters of linoleic acid, fatty esters of linolic acid, linseed oil, or mixtures thereof.

29. The process of claim 27 comprises the chain transfer agent methyl styrene dimer, n-dodecylmercaptan, terpinoline, thioglycolate, fatty esters of linoleic acid, fatty esters of linolic acid, linseed oil, or mixtures thereof.

30. The process of claim 26 comprises the comonomer acrylonitrile.

31. The process of claim 30 comprises the polymerization initiator dibenzoyl peroxide; 1,1-di(t-butyl peroxy)cyclohexane; t-butyl peroxy 2-ethyl hexanoate; or mixtures thereof.

32. The process of claim 30 comprises the chain transfer agent methyl styrene dimer, n-dodecylmercaptan, terpinoline, thioglycolate, fatty esters of linoleic acid, fatty esters of linolic acid, linseed oil, or mixtures thereof.

33. The process of claim 31 comprises the chain transfer agent methyl styrene dimer, n-dodecylmercaptan, terpinoline, thioglycolate, fatty esters of linoleic acid, fatty esters of linolic acid, linseed oil, or mixtures thereof.

34. The process of claim 22, 23, 24, 25, 26, 27, 28, 29, 30, 31, 32, or 33 comprises the solvent ethylbenzene.

35. The process of claim 20, 21, 22, 23, 24, 25, 26, 27, 28, 29, 30, 31, 32, or 33 wherein the stable free radical comprises an ═N—O. group.

36. The process of claim 34 wherein the stable free radical comprises an ═N—O. group.

37. The process of claim 35 wherein the stable free radical is 2,2,6,6-tetramethyl-1-piperindinyloxy, 4-oxo-2,2,6,6-tetramethyl-1-piperindinyloxy, 4-hydroxy-2,2,6,6-tetramethyl-1-piperindinyloxy, or mixtures thereof.

38. The process of claim 36 wherein the stable free radical is 2,2,6,6-tetramethyl-1-piperindinyloxy, 4-oxo-2,2,6,6-tetramethyl-1-piperindinyloxy, 4-hydroxy-2,2,6,6-tetramethyl-1-piperindinyloxy, or mixtures thereof.
